(19) United States
(12) Patent Application Publication
(10) Pub. No.: US 2021/0405743 A1
(43) Pub. Date: Dec. 30, 2021

(54) DYNAMIC MEDIA ITEM DELIVERY

(71) Applicant: Apple Inc., Cupertino, CA (US)

(72) Inventors: Benjamin Hunter Boesel, Sunnyvale, CA (US); Shih Sang Chiu, San Francisco, CA (US); Jonathan Perron, Milpitas, CA (US); David H. Y. Huang, San Mateo, CA (US)

(21) Appl. No.: 17/323,845

(22) Filed: May 18, 2021

Related U.S. Application Data
(60) Provisional application No. 63/044,648, filed on Jun. 26, 2020.

(51) Int. Cl. G06F 3/01; G06N 20/00; G06N 3/04; G06F 16/583; G06F 16/587; G06F 16/58

(52) U.S. Cl. CPC G06F 3/013; G06N 20/00; G06N 3/0454; G06F 2203/011; G06F 16/587; G06F 16/5866; G06F 3/017; G06F 16/583

(57) ABSTRACT

In one implementation, a method for dynamic media item delivery. The method includes: presenting, via the display device, a first set of media items associated with first metadata; obtaining user reaction information gathered by one or more input devices while presenting the first set of media items; obtaining, via a qualitative feedback classifier, an estimated user reaction state to the first set of media items based on the user reaction information; obtaining one or more target metadata characteristics based on the estimated user reaction state and the first metadata; obtaining a second set of media items associated with second metadata that corresponds to the one or more target metadata characteristics; and presenting, via the display device, the second set of media items associated with the second metadata.

### TECHNICAL FIELD

The present disclosure generally relates to media item delivery and, in particular, to systems, methods, and methods for dynamic and/or serendipitous media item delivery.

### BACKGROUND

Firstly, in some instances, a user manually selects between groupings of images or media content that have been labeled based on geolocation, facial recognition, event, etc. For example, a user selects a Hawai′i vacation album and then manually selects a different album or photos that include a specific family member. This process is associated with multiple user inputs, which increases wear and tear on an associated input device and also consumes power. Secondly, in some instances, a user simply selects an album or event associated with a pre-sorted group of images. However, this workflow for viewing media content lacks a serendipitous nature.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating architecture in accordance with some implementations.

FIG. 2 is a block diagram of an example controller in accordance with some implementations.

FIG. 3 is a block diagram of an example electronic device in accordance with some implementations.

FIG. 4 is a block diagram of an example training architecture in accordance with some implementations.

FIG. 5 is a block diagram of an example machine learning (ML) system in accordance with some implementations.

FIG. 6 is a block diagram of an example input data processing architecture in accordance with some implementations.

FIG. 7A is a block diagram of an example dynamic media item delivery architecture in accordance with some implementations.

FIG. 7B illustrates an example data structure for a media item repository in accordance with some implementations.

FIG. 8A is a block diagram of another example dynamic media item delivery architecture in accordance with some implementations.

FIG. 8B illustrates an example data structure for a user reaction history datastore in accordance with some implementations.

FIG. 9 is a flowchart representation of a method of dynamic media item delivery in accordance with some implementations.

FIG. 10 is a block diagram of yet another example dynamic media item delivery architecture in accordance with some implementations.

FIGS. 11A-11C illustrate a sequence of instances for a serendipitous media item delivery scenario in accordance with some implementations.

FIG. 12 is a flowchart representation of a method of serendipitous media item delivery in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### SUMMARY

Various implementations disclosed herein include devices, systems, and methods for dynamic media item delivery. According to some implementations, the method is performed at a computing system including non-transitory memory and one or more processors, wherein the computing system is communicatively coupled to a display device and one or more input devices. The method includes: presenting, via the display device, a first set of media items associated with first metadata; obtaining user reaction information gathered by the one or more input devices while presenting the first set of media items; obtaining, via a qualitative feedback classifier, an estimated user reaction state to the first set of media items based on the user reaction information; obtaining one or more target metadata characteristics based on the estimated user reaction state and the first metadata; obtaining a second set of media items associated with second metadata that corresponds to the one or more target metadata characteristics; and presenting, via the display device, the second set of media items associated with the second metadata.

Various implementations disclosed herein include devices, systems, and methods for serendipitous media item delivery. According to some implementations, the method is performed at a computing system including non-transitory memory and one or more processors, wherein the computing system is communicatively coupled to a display device and one or more input devices. The method includes: presenting an animation including a first plurality of virtual objects via the display device, wherein the first plurality of virtual objects corresponds to virtual representations of a first plurality of media items, and wherein the first plurality of media items is pseudo-randomly selected from a media item repository; detecting, via the one or more input devices, a user input indicating interest in a respective virtual object associated with a particular media item in the first plurality of media items; and, in response to detecting the user input: obtaining target metadata characteristics associated with the particular media item; selecting a second plurality of media items from the media item repository associated with respective metadata characteristics that correspond to the target metadata characteristics; and presenting the animation including a second plurality of virtual objects via the display device, wherein the second plurality of virtual objects corresponds to virtual representations of the second plurality of media items from the media item repository.

In accordance with some implementations, an electronic device includes one or more displays, one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more displays, one or more processors, a non-transitory memory, and means for performing or causing performance of any of the methods described herein.

In accordance with some implementations, a computing system includes one or more processors, non-transitory memory, an interface for communicating with a display device and one or more input devices, and one or more programs; the one or more programs are stored in the non-transitory memory and configured to be executed by the one or more processors and the one or more programs include instructions for performing or causing performance of the operations of any of the methods described herein. In accordance with some implementations, a non-transitory computer readable storage medium has stored therein instructions which when executed by one or more processors of a computing system with an interface for communicating with a display device and one or more input devices, cause the computing system to perform or cause performance of the operations of any of the methods described herein. In accordance with some implementations, a computing system includes one or more processors, non-transitory memory, an interface for communicating with a display device and one or more input devices, and means for performing or causing performance of the operations of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, ahead mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

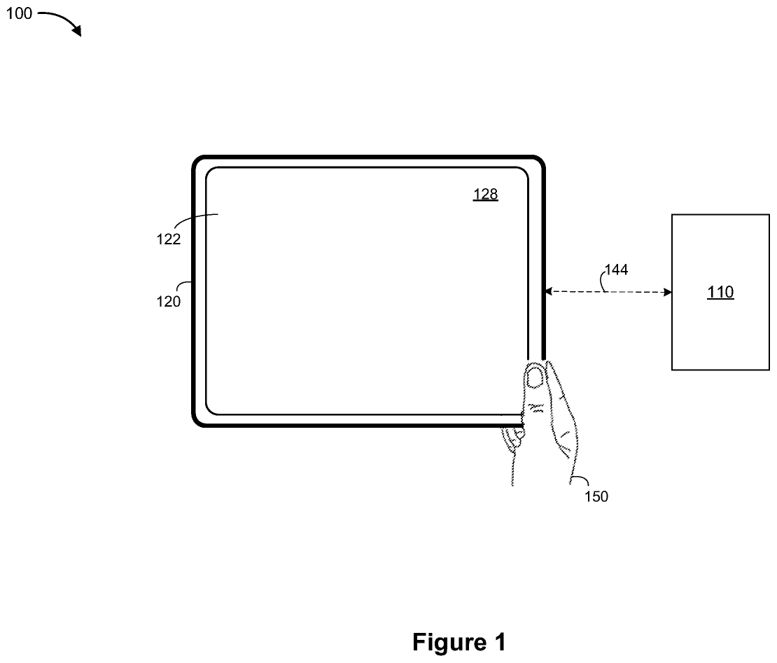

FIG. 1 is a block diagram of an example operating architecture 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating architecture 100 includes an optional controller 110 and an electronic device 120 (e.g., a tablet, mobile phone, laptop, near-eye system, wearable computing device, or the like).

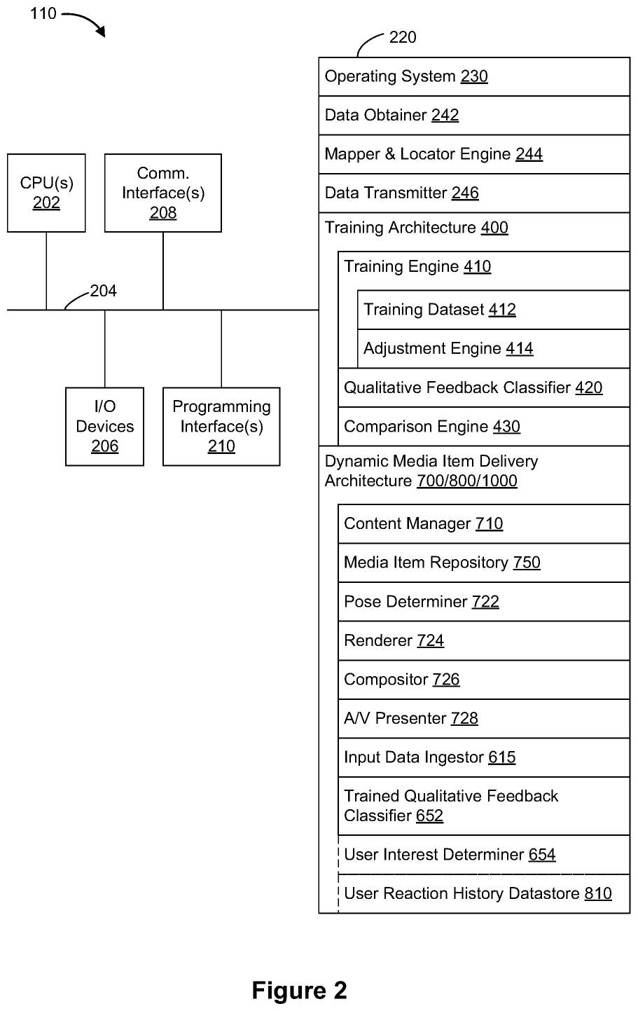

In some implementations, the controller 110 is configured to manage and coordinate an XR experience (sometimes also referred to herein as a “XR environment” or a “virtual environment” or a “graphical environment”) for a user 150 and zero or more other users. In some implementations, the controller 110 includes a suitable combination of software, firmware, and/or hardware. The controller 110 is described in greater detail below with respect to FIG. 2. In some implementations, the controller 110 is a computing device that is local or remote relative to a physical environment associated with the user 150. For example, the controller 110 is a local server located within the physical environment. In another example, the controller 110 is a remote server located outside of the physical environment (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In some implementations, the functions of the controller 110 are provided by the electronic device 120. As such, in some implementations, the components of the controller 110 are integrated into the electronic device 120.

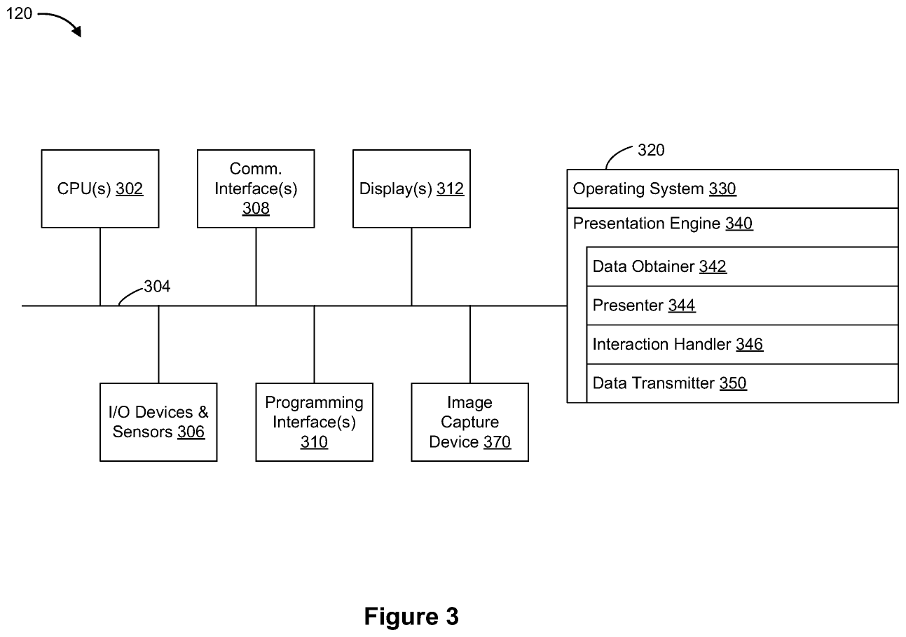

In some implementations, the electronic device 120 is configured to present audio and/or video content to the user 150. In some implementations, the electronic device 120 is configured to present a user interface (UI) and/or an XR environment 128 via the display 122 to the user 150. In some implementations, the electronic device 120 includes a suitable combination of software, firmware, and/or hardware. The electronic device 120 is described in greater detail below with respect to FIG. 3.

According to some implementations, the electronic device 120 presents an XR experience to the user 150 while the user 150 is physically present within the physical environment. As such, in some implementations, the user 150 holds the electronic device 120 in his/her hand(s). In some implementations, while presenting the XR experience, the electronic device 120 is configured to present XR content and to enable video pass-through of the physical environment on a display 122. For example, the XR environment 128, including the XR content, is volumetric or three-dimensional (3D).

In one example, the XR content corresponds to display-locked content such that the XR content remains displayed at the same location on the display 122 despite translational and/or rotational movement of the electronic device 120. As another example, the XR content corresponds to world-locked content such that the XR content remains displayed at its origin location as the electronic device 120 detects translational and/or rotational movement. As such, in this example, if the field-of-view (FOV) of the electronic device 120 does not include the origin location, the XR environment 128 will not include the XR content.

In some implementations, the display 122 corresponds to an additive display that enables optical see-through of the physical environment. For example, the display 122 correspond to a transparent lens, and the electronic device 120 corresponds to a pair of glasses worn by the user 150. As such, in some implementations, the electronic device 120 presents a user interface by projecting the XR content onto the additive display, which is, in turn, overlaid on the physical environment from the perspective of the user 150. In some implementations, the electronic device 120 presents the user interface by displaying the XR content on the additive display, which is, in turn, overlaid on the physical environment from the perspective of the user 150.

In some implementations, the user 150 wears the electronic device 120 such as a near-eye system. As such, the electronic device 120 includes one or more displays provided to display the XR content (e.g., a single display or one for each eye). For example, the electronic device 120 encloses the FOV of the user 150. In such implementations, the electronic device 120 presents the XR environment 128 by displaying data corresponding to the XR environment 128 on the one or more displays or by projecting data corresponding to the XR environment 128 onto the retinas of the user 150.

In some implementations, the electronic device 120 includes an integrated display (e.g., a built-in display) that displays the XR environment 128. In some implementations, the electronic device 120 includes a head-mountable enclosure. In various implementations, the head-mountable enclosure includes an attachment region to which another device with a display can be attached. For example, in some implementations, the electronic device 120 can be attached to the head-mountable enclosure. In various implementations, the head-mountable enclosure is shaped to form a receptacle for receiving another device that includes a display (e.g., the electronic device 120). For example, in some implementations, the electronic device 120 slides/snaps into or otherwise attaches to the head-mountable enclosure. In some implementations, the display of the device attached to the head-mountable enclosure presents (e.g., displays) the XR environment 128. In some implementations, the electronic device 120 is replaced with an XR chamber, enclosure, or room configured to present XR content in which the user 150 does not wear the electronic device 120.

In some implementations, the controller 110 and/or the electronic device 120 cause an XR representation of the user 150 to move within the XR environment 128 based on movement information (e.g., body pose data, eye tracking data, hand/limb tracking data, etc.) from the electronic device 120 and/or optional remote input devices within the physical environment. In some implementations, the optional remote input devices correspond to fixed or movable sensory equipment within the physical environment (e.g., image sensors, depth sensors, infrared (IR) sensors, event cameras, microphones, etc.). In some implementations, each of the remote input devices is configured to collect/capture input data and provide the input data to the controller 110 and/or the electronic device 120 while the user 150 is physically within the physical environment. In some implementations, the remote input devices include microphones, and the input data includes audio data associated with the user 150 (e.g., speech samples). In some implementations, the remote input devices include image sensors (e.g., cameras), and the input data includes images of the user 150. In some implementations, the input data characterizes body poses of the user 150 at different times. In some implementations, the input data characterizes head poses of the user 150 at different times. In some implementations, the input data characterizes hand tracking information associated with the hands of the user 150 at different times. In some implementations, the input data characterizes the velocity and/or acceleration of body parts of the user 150 such as his/her hands. In some implementations, the input data indicates joint positions and/or joint orientations of the user 150. In some implementations, the remote input devices include feedback devices such as speakers, lights, or the like.

FIG. 2 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some implementations, the one or more communication buses 204 include circuitry that interconnects and controls communications between system components. In some implementations, the one or more I/O devices 206 include at least one of a keyboard, a mouse, a touchpad, a touch-screen, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof described below with respect to FIG. 2.

The operating system 230 includes procedures for handling various basic system services and for performing hardware dependent tasks.

In some implementations, the data obtainer 242 is configured to obtain data (e.g., captured image frames of the physical environment, presentation data, input data, user interaction data, camera pose tracking information, eye tracking information, head/body pose tracking information, hand/limb tracking information, sensor data, location data, etc.) from at least one of the I/O devices 206 of the controller 110, the electronic device 120, and the optional remote input devices. To that end, in various implementations, the data obtainer 242 includes instructions and/or logic therefor, and heuristics and metadata therefor.

In some implementations, the mapper and locator engine 244 is configured to map the physical environment and to track the position/location of at least the electronic device 120 with respect to the physical environment. To that end, in various implementations, the mapper and locator engine 244 includes instructions and/or logic therefor, and heuristics and metadata therefor.

In some implementations, the data transmitter 246 is configured to transmit data (e.g., presentation data such as rendered image frames associated with the XR environment, location data, etc.) to at least the electronic device 120. To that end, in various implementations, the data transmitter 246 includes instructions and/or logic therefor, and heuristics and metadata therefor.

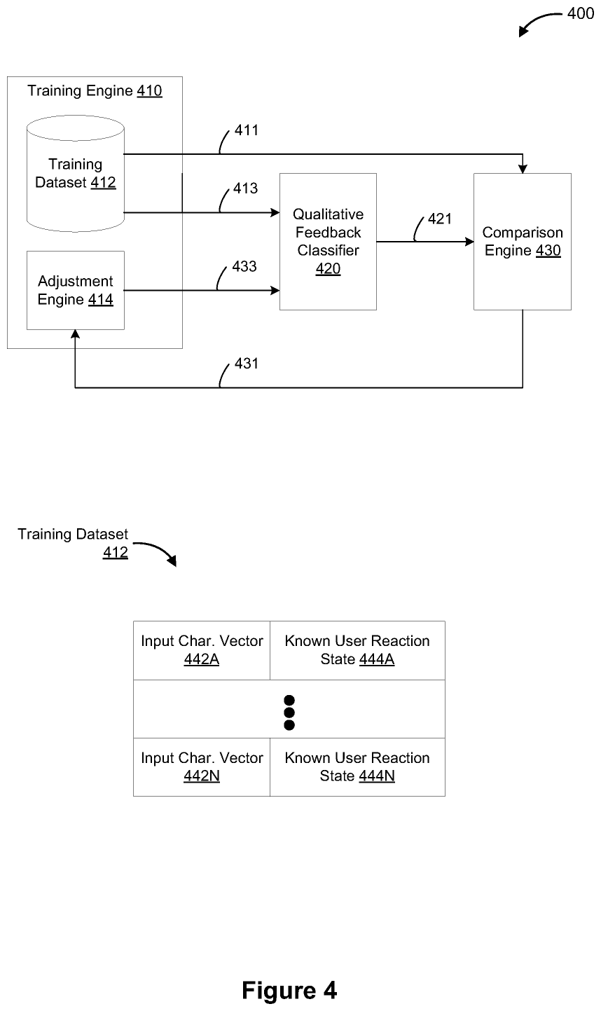

In some implementations, a training architecture 400 is configured to train various portions of a qualitative feedback classifier 420. The training architecture 400 is described in more detail below with reference to FIG. 4. To that end, in various implementations, the training architecture 400 includes instructions and/or logic therefor, and heuristics and metadata therefor. In some implementations, the training architecture 400 includes a training engine 410, the qualitative feedback classifier 420, and a comparison engine 430.

In some implementations, the training engine 410 includes a training dataset 412 and an adjustment engine 414. According to some implementations, the training dataset 412 includes an input characterization vector and known user reaction state pairings. For example, a respective input characterization vector is associated with user reaction information that includes intrinsic user feedback measurements that are crowd-sourced, user-specific, and/or system-generated. In this example, the intrinsic user feedback measurements may include at least one of body pose characteristics, speech characteristics, a pupil dilation value, a heart rate value, a respiratory rate value, a blood glucose value, a blood oximetry value, and/or the like. Continuing with this example, a known user reaction state corresponds to a probable user reaction (e.g., an emotional state, mood, or the like) for the respective input characterization vector.

As such, during training, the training engine 410 feeds a respective input characterization vector from the training dataset 412 to the qualitative feedback classifier 420. In some implementations, the qualitative feedback classifier 420 is configured to process the respective input characterization vector from the training dataset 412 and output an estimated user reaction state. In some implementations, the qualitative feedback classifier 420 corresponds to a look-up engine or a machine learning (ML) system such as a neural network, a convolutional neural network (CNN), a recurrent neural network (RNN), a deep neural network (DNN), a state vector machine (SVM), a random forest algorithm, or the like.

In some implementations, the comparison engine 430 is configured to compare the estimated user reaction state to the known user reaction state and output an error delta value. To that end, in various implementations, the comparison engine 430 includes instructions and/or logic therefor, and heuristics and metadata therefor.

In some implementations, the adjustment engine 414 is configured to determine whether the error delta value satisfies a threshold convergence value. If the error delta value does not satisfy the threshold convergence value, the adjustment engine 414 is configured to adjust one or more operating parameters (e.g., filter weights or the like) of the qualitative feedback classifier 420. If the error delta value satisfies the threshold convergence value, the qualitative feedback classifier 420 is considered to be trained and ready for runtime use. Furthermore, if the error delta value satisfies the threshold convergence value, the adjustment engine 414 is configured to forgo adjusting the one or more operating parameters of the qualitative feedback classifier 420. To that end, in various implementations, the adjustment engine 414 includes instructions and/or logic therefor, and heuristics and metadata therefor.

Although the training engine 410, the qualitative feedback classifier 420, and the comparison engine 430 are shown as residing on a single device (e.g., the controller 110), it should be understood that in other implementations, any combination of the training engine 410, the qualitative feedback classifier 420, and the comparison engine 430 may be located in separate computing devices.

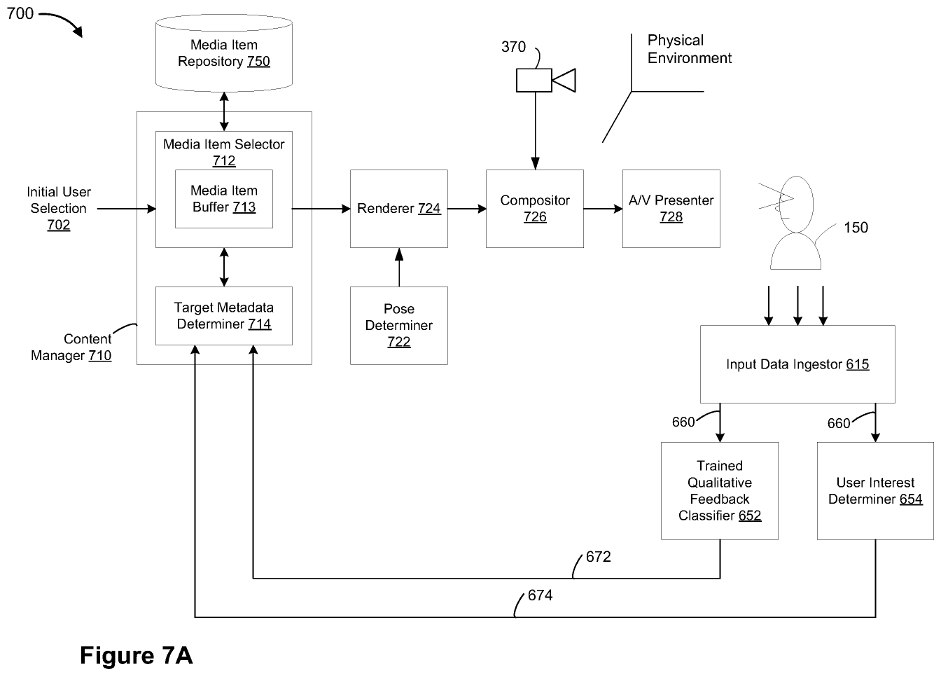

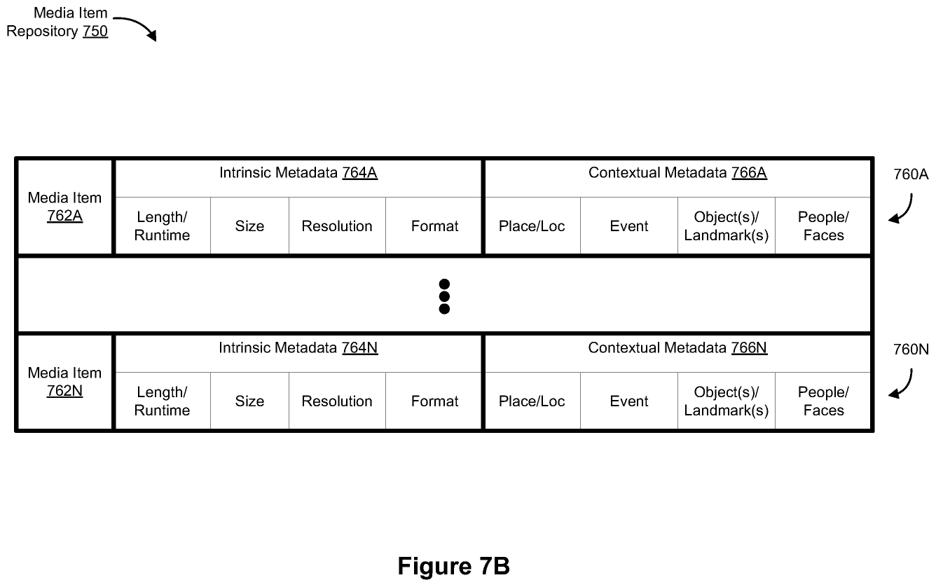

In some implementations, a dynamic media item delivery architecture 700/800/1000 is configured to delivery media items in a dynamic fashion based on user reaction and/or user interest indication(s) thereto. Example dynamic media item delivery architectures 700, 800, and 1000 are described in more detail below with reference to FIGS. 7A, 8A, and 10, respectively. To that end, in various implementations, the dynamic media item delivery architecture 700/800/1000 includes instructions and/or logic therefor, and heuristics and metadata therefor. In some implementations, the dynamic media item delivery architecture 700/800/1000 includes a content manager 710, a media item repository 750, a pose determiner 722, a renderer 724, a compositor 726, an audio/visual (A/V) presenter 728, an input data ingestor 615, a trained qualitative feedback classifier 652, an optional user interest determiner 654, and an optional user reaction history datastore 810.

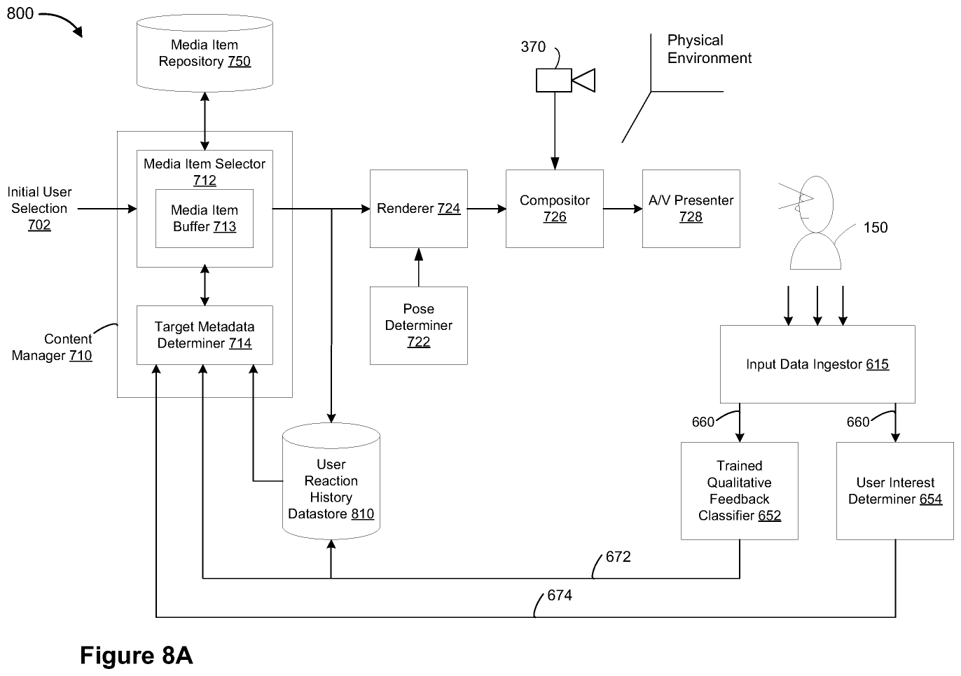

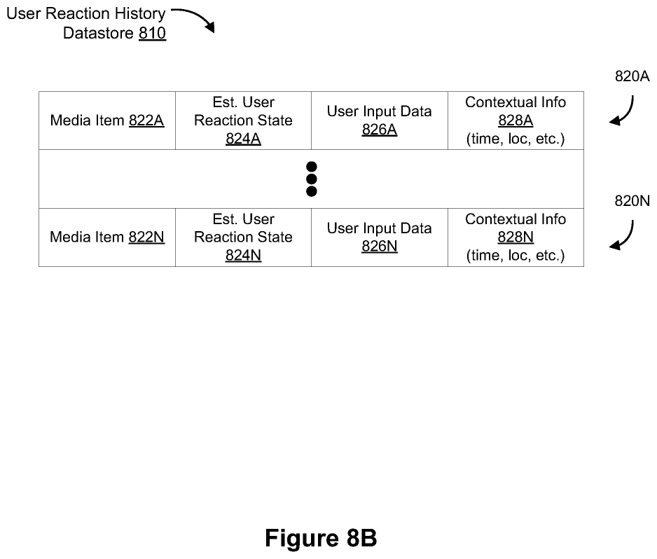

In some implementations, as shown in FIGS. 7A and 8A, the content manager 710 is configured to select a first set of media items from a media item repository 750 based on an initial user selection or the like. In some implementations, as shown in FIGS. 7A and 8A, the content manager 710 is also configured to select a second set of media items from the media item repository 750 based on an estimated user reaction state to the first set of media items and/or a user interest indication.

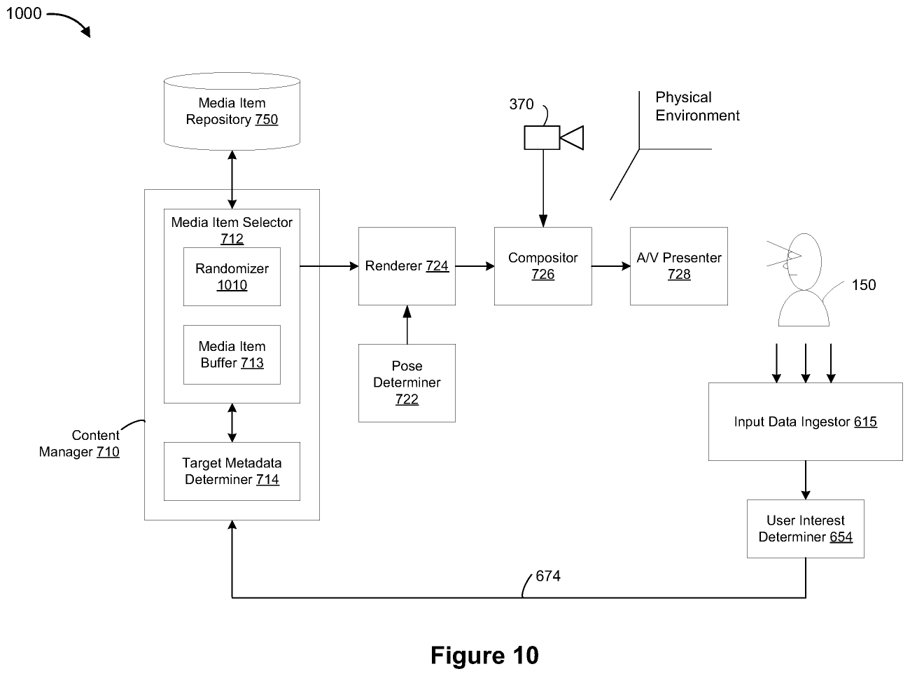

In some implementations, as shown in FIG. 10, the content manager 710 is configured to randomly or pseudo-randomly select the first set of media items from the media item repository 750. In some implementations, as shown in FIG. 10, the content manager 710 is also configured to select a second set of media items from the media item repository 750 based on the user interest indication.

The content manager 710 and the media item selection processes are described in more detail below with reference to FIGS. 7A, 8A, and 10. To that end, in various implementations, the content manager 710 includes instructions and/or logic therefor, and heuristics and metadata therefor.

In some implementations, the media item repository 750 includes a plurality of media items such as audio/visual (A/V) content and/or a plurality of virtual/XR objects, items, scenery, and/or the like. In some implementations, the media item repository 750 is stored locally and/or remotely relative to the controller 110. In some implementations, the media item repository 750 is pre-populated or manually authored by the user 150. The media item repository 750 is described in more detail below with reference to FIG. 7B.

In some implementations, the pose determiner 722 is configured to determine a current camera pose of the electronic device 120 and/or the user 150 relative to the A/V content and/or virtual/XR content. To that end, in various implementations, the pose determiner 722 includes instructions and/or logic therefor, and heuristics and metadata therefor.

In some implementations, the renderer 724 is configured to render A/V content and/or virtual/XR content from the media item repository 750 according to a current camera pose relative thereto. To that end, in various implementations, the renderer 724 includes instructions and/or logic therefor, and heuristics and metadata therefor.

In some implementations, the compositor 726 is configured to composite the rendered A/V content and/or virtual/XR content with image(s) of the physical environment to produce rendered image frames. In some implementations, the compositor 726 obtains (e.g., receives, retrieves, determines/generates, or otherwise accesses) depth information (e.g., a point cloud, mesh, or the like) associated with the scene (e.g., the physical environment in FIG. 1) to maintain z-order between the rendered A/V content and/or virtual/XR content, and physical objects in the physical environment. To that end, in various implementations, the compositor 726 includes instructions and/or logic therefor, and heuristics and metadata therefor.

In some implementations, the A/V presenter 728 is configured to present or cause presentation of the rendered image frames (e.g., via the one or more displays 312 or the like). To that end, in various implementations, the A/V presenter 728 includes instructions and/or logic therefor, and heuristics and metadata therefor.

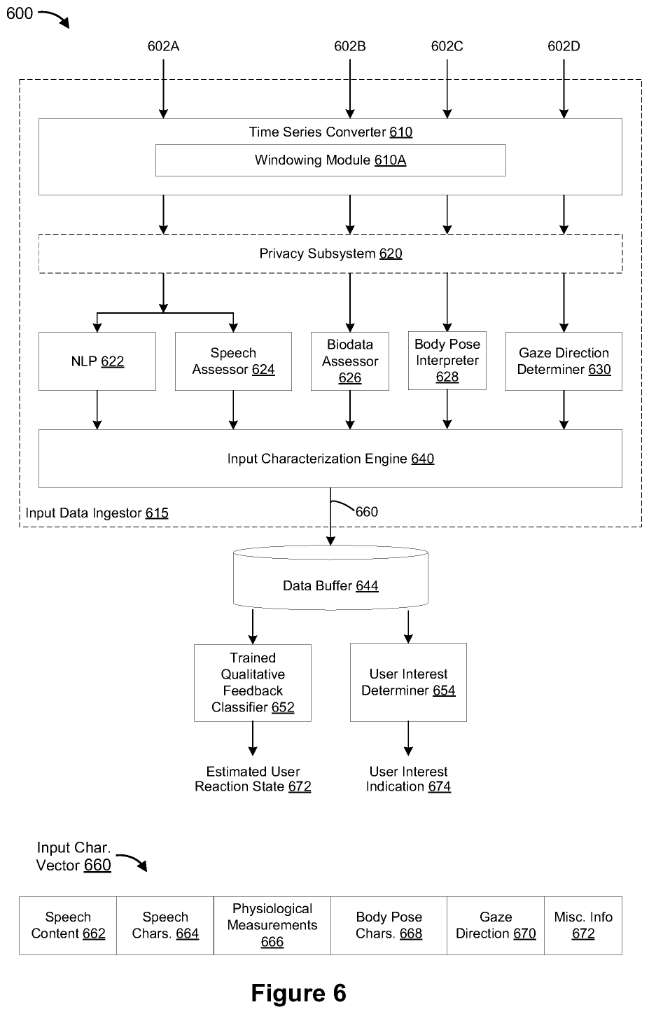

In some implementations, the input data ingestor 615 is configured to ingest user input data such as user reaction information and/or one or more affirmative user feedback inputs gathered by the one or more input devices. According to some implementations, the one or more input devices include at least one of an eye tracking engine, a body pose tracking engine, a heart rate monitor, a respiratory rate monitor, a blood glucose monitor, a blood oximetry monitor, a microphone, an image sensor, a body pose tracking engine, a head pose tracking engine, a limb/hand tracking engine, or the like. The input data ingestor 615 is described in more detail below with reference to FIG. 6. To that end, in various implementations, the input data ingestor 615 includes instructions and/or logic therefor, and heuristics and metadata therefor.

In some implementations, the trained qualitative feedback classifier 652 is configured to generate an estimated user reaction state (or a confidence score related thereto) to the first or second sets of media items based on the user reaction information (or a user characterization vector derived therefrom). The trained qualitative feedback classifier 652 is described in more detail below with reference to FIGS. 6, 7A, and 8A. To that end, in various implementations, the trained qualitative feedback classifier 652 includes instructions and/or logic therefor, and heuristics and metadata therefor.

In some implementations, the user interest determiner 654 is configured to generate a user interest indication based on the one or more affirmative user feedback inputs. The user interest determiner 654 is described in more detail below with reference to FIGS. 6, 7A, 8A, and 10. To that end, in various implementations, the user interest determiner 654 includes instructions and/or logic therefor, and heuristics and metadata therefor.

In some implementations, the optional user reaction history datastore 810 includes a historical record of past media items presented to the user 150 in association with the user 150's estimated user reaction state with respect to those past media items. In some implementations, the optional user reaction history datastore 810 is stored locally and/or remotely relative to the controller 110. In some implementations, the optional user reaction history datastore 810 is populated over time by monitoring the reactions of the user 150. For example, the user reaction history datastore 810 is populated after detecting an opt-in input from the user 150. The optional user reaction history datastore 810 is described in more detail below with reference to FIGS. 8A and 8B.

Although the data obtainer 242, the mapper and locator engine 244, the data transmitter 246, the training architecture 400, and the dynamic media item delivery architecture 700/800/1000 are shown as residing on a single device (e.g., the controller 110), it should be understood that in other implementations, any combination of the data obtainer 242, the mapper and locator engine 244, the data transmitter 246, the training architecture 400, and the dynamic media item delivery architecture 700/800/1000 may be located in separate computing devices.

In some implementations, the functions and/or components of the controller 110 are combined with or provided by the electronic device 120 shown below in FIG. 3. Moreover, FIG. 2 is intended more as a functional description of the various features which be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 3 is a block diagram of an example of the electronic device 120 (e.g., a mobile phone, tablet, laptop, near-eye system, wearable computing device, or the like) in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations, the electronic device 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more displays 312, an image capture device 370 (e.g., one or more optional interior- and/or exterior-facing image sensors), a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a magnetometer, a thermometer, one or more physiological sensors (e.g., blood pressure monitor, heart rate monitor, blood oximetry monitor, blood glucose monitor, etc.), one or more microphones, one or more speakers, a haptics engine, a heating and/or cooling unit, a skin shear engine, one or more depth sensors (e.g., structured light, time-of-flight, LiDAR, or the like), a localization and mapping engine, an eye tracking engine, a body/head pose tracking engine, a hand/limb tracking engine, a camera pose tracking engine, or the like.

In some implementations, the one or more displays 312 are configured to present the XR environment to the user. In some implementations, the one or more displays 312 are also configured to present flat video content to the user (e.g., a 2-dimensional or “flat” AVI, FLV, WMV, MOV, MP4, or the like file associated with a TV episode or a movie, or live video pass-through of the physical environment). In some implementations, the one or more displays 312 correspond to touchscreen displays. In some implementations, the one or more displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more displays 312 correspond to diffractive, reflective, polarized, holographic, etc. waveguide displays. For example, the electronic device 120 includes a single display. In another example, the electronic device 120 includes a display for each eye of the user. In some implementations, the one or more displays 312 are capable of presenting AR and VR content. In some implementations, the one or more displays 312 are capable of presenting AR or VR content.

In some implementations, the image capture device 370 correspond to one or more RGB cameras (e.g., with a complementary metal-oxide-semiconductor (CMOS) image sensor or a charge-coupled device (CCD) image sensor), IR image sensors, event-based cameras, and/or the like. In some implementations, the image capture device 370 includes a lens assembly, a photodiode, and a front-end architecture.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and an XR presentation engine 340.

The operating system 330 includes procedures for handling various basic system services and for performing hardware dependent tasks. In some implementations, the presentation engine 340 is configured to present media items and/or XR content to the user via the one or more displays 312. To that end, in various implementations, the presentation engine 340 includes a data obtainer 342, a presenter 344, an interaction handler 346, and a data transmitter 350.

In some implementations, the data obtainer 342 is configured to obtain data (e.g., presentation data such as rendered image frames associated with the user interface/XR environment, input data, user interaction data, head tracking information, camera pose tracking information, eye tracking information, sensor data, location data, etc.) from at least one of the I/O devices and sensors 306 of the electronic device 120, the controller 110, and the remote input devices. To that end, in various implementations, the data obtainer 342 includes instructions and/or logic therefor, and heuristics and metadata therefor.

In some implementations, the presenter 344 is configured to present and update media items and/or XR content (e.g., the rendered image frames associated with the user interface/XR environment) via the one or more displays 312. To that end, in various implementations, the presenter 344 includes instructions and/or logic therefor, and heuristics and metadata therefor.

In some implementations, the interaction handler 346 is configured to detect user interactions with the presented media items and/or XR content. To that end, in various implementations, the interaction handler 346 includes instructions and/or logic therefor, and heuristics and metadata therefor.

In some implementations, the data transmitter 350 is configured to transmit data (e.g., presentation data, location data, user interaction data, head tracking information, camera pose tracking information, eye tracking information, etc.) to at least the controller 110. To that end, in various implementations, the data transmitter 350 includes instructions and/or logic therefor, and heuristics and metadata therefor.

Although the data obtainer 342, the presenter 344, the interaction handler 346, and the data transmitter 350 are shown as residing on a single device (e.g., the electronic device 120), it should be understood that in other implementations, any combination of the data obtainer 342, the presenter 344, the interaction handler 346, and the data transmitter 350 may be located in separate computing devices.

Moreover, FIG. 3 is intended more as a functional description of the various features which be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 4 is a block diagram of an example training architecture 400 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the training architecture 40 is included in a computing system such as the controller 110 shown in FIGS. 1 and 2; the electronic device 120 shown in FIGS. 1 and 3; and/or a suitable combination thereof.

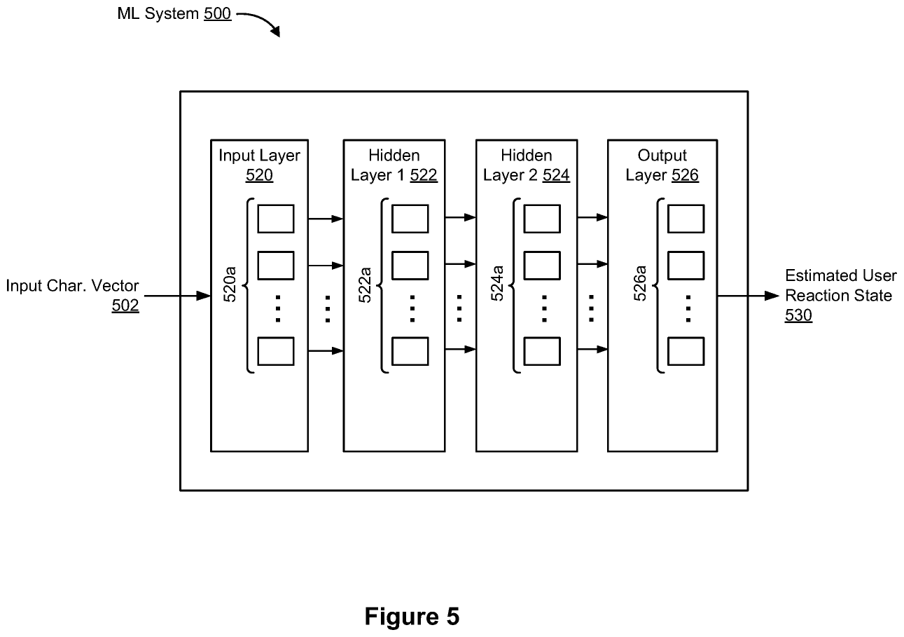

According to some implementations, the training architecture 400 (e.g., the training implementation) includes the training engine 410, the qualitative feedback classifier 420, and a comparison engine 430. In some implementations, the training engine 210 includes at least a training dataset 412 and an adjustment unit 414. In some implementations, the qualitative feedback classifier 420 includes at least a machine learning (ML) system such as the ML system 500 in FIG. 5. To that end, in some implementations, the qualitative feedback classifier 420 corresponds to a neural network, CNN, RNN, DNN, SVM, random forest algorithm, or the like.

In some implementations, in a training mode, the training architecture 400 is configured to train the qualitative feedback classifier 420 based at least in part on the training dataset 412. As shown in FIG. 4, the training dataset 412 includes an input characterization vector and known user reaction state pairings. In FIG. 4, the input characterization vector 442A corresponds to a probable known user reaction state 444A, and the input characterization vector 442N corresponds to a probable known user reaction state 444N. One of ordinary skill in the art will appreciate that the structure of the training dataset 412 and the components therein may be different in various other implementations.

According to some implementations, the input characterization vector 442A includes intrinsic user feedback measurements that are crowd-sourced, user-specific, and/or system-generated. In this example, the intrinsic user feedback measurements may include at least one of body pose characteristics, speech characteristics, a pupil dilation value, a heart rate value, a respiratory rate value, a blood glucose value, a blood oximetry value, or the like. In other words, the intrinsic user feedback measurements include sensor information such as audio data, physiological data, body pose data, eye tracking data, and/or the like. As a non-limiting example, a suite of sensor information (e.g., intrinsic user feedback measurements) associated with a known reaction state for the user that corresponds to a state of happiness includes: audio data that indicates a speech characteristic of a slow speech cadence, physiological data that includes a heart rate of 90 beats-per-minute (BPM), pupil eye diameter of 3.0 mm, body pose data of the user with his or her arms wide open, and/or eye tracking data of a gaze focused on a particular subject. As another non-limiting example, a suite of sensor information (e.g., intrinsic user feedback measurements) associated with a known state for the user that corresponds to a state of stress includes: audio data that indicates a speech characteristic associated with a stammering speech pattern, physiological data that includes a heart rate beat of 120 BPM, pupil eye dilation diameter of 7.00 mm, body pose data of the user with his or her arms crossed, and/or eye tracking data of a shifty eye gaze. As yet another example, a suite of sensor information (e.g., intrinsic user feedback measurements) associated with a known state for the user that corresponds to a state of calmness includes: audio data that includes a transcript saying “I am relaxed,” audio data that indicates slow speech pattern, physiological data that includes a heart rate of 80 BPM, pupil eye dilation diameter of 4.0 mm, body pose data of arms folded behind the head of the user, and/or eye tracking data of a relaxed gaze.

As such, during training, the training engine 410 feeds a respective input characterization vector 413 from the training dataset 412 to the qualitative feedback classifier 420. In some implementations, the qualitative feedback classifier 420 processes the respective input characterization vector 413 from the training dataset 412 and outputs an estimated user reaction state 421.

In some implementations, the comparison engine 430 compares the estimated user reaction state 421 to a known user reaction state 411 from the training dataset 412 that is associated with the respective input characterization vector 413 in order to generate an error delta value 431 between the estimated user reaction state 421 and the known user reaction state 411.

In some implementations, the adjustment engine 414 determines whether the error delta value 431 satisfies a threshold convergence value. If the error delta value 431 does not satisfy the threshold convergence value, the adjustment engine 414 adjusts one or more operating parameters 433 (e.g., filter weights or the like) of the qualitative feedback classifier 420. If the error delta value 431 satisfies the threshold convergence value, the qualitative feedback classifier 420 is considered to be trained and ready for runtime use. Furthermore, if the error delta value 431 satisfies the threshold convergence value, the adjustment engine 414 forgoes adjusting the one or more operating parameters 433 of the qualitative feedback classifier 420. In some implementations, the threshold convergence value corresponds to a predefined value. In some implementations, the threshold convergence value corresponds to a deterministic value.

Although the training engine 410, the qualitative feedback classifier 420, and the comparison engine 430 are shown as residing on a single device (e.g., the training architecture 400), it should be understood that in other implementations, any combination of the training engine 410, the qualitative feedback classifier 420, and the comparison engine 430 may be located in separate computing devices.

Moreover, FIG. 4 is intended more as functional description of the various features which may be present in a particular implementation as opposed to a structural schematic of the implementations described herein. As recognized by those of ordinary skill in the art, items shown separately could be combined and some items could be separated. For example, some functional modules shown separately in FIG. 4 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 5 is a block diagram of an example machine learning (ML) system 500 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations, the ML system 500 includes an input layer 520, a first hidden layer 522, a second hidden layer 524, and an output layer 526. While the ML system 500 includes two hidden layers as an example, those of ordinary skill in the art will appreciate from the present disclosure that one or more additional hidden layers are also present in various implementations. Adding additional hidden layers adds to the computational complexity and memory demands but may improve performance for some applications.

In various implementations, the input layer 520 is coupled (e.g., configured) to receive an input characterization vector 502 (e.g., the input characterization vector 422A shown in FIG. 4). The features and components of an example input characterization vector 660 are described below in greater detail with respect to FIG. 6. For example, the input layer 520 receives the input characterization vector 502 from an input characterization engine (e.g., the input characterization engine 640 or the related data buffer 644 shown in FIG. 6). In various implementations, the input layer 520 includes a number of long short-term memory (LSTM) logic units 520a or the like, which are also referred to as model(s) of neurons by those of ordinary skill in the art. In some such implementations, an input matrix from the features to the LSTM logic units 520a include rectangular matrices. For example, the size of this matrix is a function of the number of features included in the feature stream.

In some implementations, the first hidden layer 522 includes a number of LSTM logic units 522a or the like. As illustrated in the example of FIG. 5, the first hidden layer 522 receives its inputs from the input layer 520. For example, the first hidden layer 522 performs one or more of following: a convolutional operation, a nonlinearity operation, a normalization operation, a pooling operation, and/or the like.

In some implementations, the second hidden layer 524 includes a number of LSTM logic units 524a or the like. In some implementations, the number of LSTM logic units 524a is the same as or is similar to the number of LSTM logic units 520a in the input layer 320 or the number of LSTM logic units 522a in the first hidden layer 522. As illustrated in the example of FIG. 5 the second hidden layer 524 receives its inputs from the first hidden layer 522. Additionally, and/or alternatively, in some implementations, the second hidden layer 524 receives its inputs from the input layer 520. For example, the second hidden layer 524 performs one or more of following: a convolutional operation, a nonlinearity operation, a normalization operation, a pooling operation, and/or the like.

In some implementations, the output layer 526 includes a number of LSTM logic units 526a or the like. In some implementations, the number of LSTM logic units 526a is the same as or is similar to the number of LSTM logic units 520a in the input layer 520, the number of LSTM logic units 522a in the first hidden layer 522, or the number of LSTM logic units 524a in the second hidden layer 524. In some implementations, the output layer 526 is a task-dependent layer that performs a computer vision related task such as feature extraction, object recognition, object detection, pose estimation, or the like. In some implementations, the output layer 526 includes an implementation of a multinomial logistic function (e.g., a soft-max function) that produces an estimated user reaction state 530.

One of ordinary skill in the art will appreciate that the LSTM logic units shown in FIG. 5 may be replaced with various other ML components. Furthermore, one of ordinary skill in the art will appreciate that the ML system 500 may be structured or designed in myriad ways in other implementations to ingest the input characterization vector 502 and output the estimated user reaction state 530.

Moreover, FIG. 5 is intended more as a functional description of the various features which be present in a particular implementation as opposed to a structural schematic of the implementations described herein. As recognized by those of ordinary skill in the art, items shown separately could be combined and some items could be separated. For example, some functional modules shown separately in FIG. 5 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 6 is a block diagram of an example input data processing architecture 600 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the input data processing architecture 600 is included in a computing system such as the controller 110 shown in FIGS. 1 and 2; the electronic device 120 shown in FIGS. 1 and 3; and/or a suitable combination thereof.

As shown in FIG. 6, after or while presenting a first set of media items, the input data processing architecture 600 (e.g., the run-time implementation) obtains input data (sometimes also referred to herein as “sensor data” or “sensor information”) associated with a plurality of modalities, including audio data 602A, physiological measurements 602B (e.g., a heart rate value, a respiratory rate value, a blood glucose value, a blood oximetry value, and/or the like), body pose data 602C (e.g., body language information, joint position information, hand/limb position information, head tilt information, and/or the like), and eye tracking data 602D (e.g., a pupil dilation value, a gaze direction, or the like).

For example, the audio data 602A corresponds to audio signals captured by one or more microphones of the controller 110, the electronic device 120, and/or the optional remote input devices. For example, the physiological measurements 602B correspond to information captured by one or more sensors of the electronic device 120 and/or one or more wearable sensors on the user 150's body that are communicatively coupled with the controller 110 and/or the electronic device 120. As one example, the body pose data 602C corresponds to data captured by one or more image sensors of the controller 110, the electronic device 120, and/or the optional remote input devices. As another example, the body pose data 602C corresponds to data obtained from one or more wearable sensors on the user 150's body that are communicatively coupled with the controller 110 and/or the electronic device 120. For example, the eye tracking data 602D corresponds to images captured by one or more image sensors of the controller 110, the electronic device 120, and/or the optional remote input devices.

According to some implementations, the audio data 602A corresponds to an ongoing or continuous time series of values. In turn, the time series converter 610 is configured to generate one or more temporal frames of audio data from a continuous stream of audio data. Each temporal frame of audio data includes a temporal portion of the audio data 602A. In some implementations, the time series converter 610 includes a windowing module 610A that is configured to mark and separate one or more temporal frames or portions of the audio data 602A for times T₁, T₂, . . . , T_{N}.

In some implementations, each temporal frame of the audio data 602A is conditioned by a pre-filter (not shown). For example, in some implementations, pre-filtering includes band-pass filtering to isolate and/or emphasize the portion of the frequency spectrum typically associated with human speech. In some implementations, pre-filtering includes pre-emphasizing portions of one or more temporal frames of the audio data in order to adjust the spectral composition of the one or more temporal frames of the audio data 602A. Additionally, and/or alternatively, in some implementations, the windowing module 610A is configured to retrieve the audio data 602A from a non-transitory memory. Additionally, and/or alternatively, in some implementations, pre-filtering includes filtering the audio data 602A using a low-noise amplifier (LNA) in order to substantially set a noise floor for further processing. In some implementations, a pre-filtering LNA is arranged prior to the time series converter 610. Those of ordinary skill in the art will appreciate that numerous other pre-filtering techniques may be applied to the audio data, and those highlighted herein are merely examples of numerous pre-filtering options available.

According to some implementations, the physiological measurements 602B corresponds to an ongoing or continuous time series of values. In turn, the time series converter 610 is configured to generate one or more temporal frames of physiological measurement data from a continuous stream of physiological measurement data. Each temporal frame of physiological measurement data includes a temporal portion of the physiological measurements 602B. In some implementations, the time series converter 410 includes a windowing module 610A that is configured to mark and separate one or more portions of the physiological measurements 602B for times T₁, T₂, . . . , T_{N}. In some implementations, each temporal frame of the physiological measurements 602B is conditioned by a pre-filter or otherwise pre-processed.

According to some implementations, the body pose data 602C corresponds to an ongoing or continuous time series of images or values. In turn, the time series converter 610 is configured to generate one or more temporal frames of body pose data from a continuous stream of body pose data. Each temporal frame of body pose data includes a temporal portion of the body pose data 602C. In some implementations, the time series converter 610 includes a windowing module 610A that is configured to mark and separate one or more temporal frames or portions of the body pose data 602C for times T₁, T₂, . . . , T_{N}. In some implementations, each temporal frame of the body pose data 602C is conditioned by a pre-filter or otherwise pre-processed.

According to some implementations, the eye tracking data 602D corresponds to an ongoing or continuous time series of images or values. In turn, the time series converter 410 is configured to generate one or more temporal frames of eye tracking data from a continuous stream of eye tracking data. Each temporal frame of eye tracking data includes a temporal portion of the eye tracking data 602D. In some implementations, the time series converter 610 includes a windowing module 610A that is configured to mark and separate one or more temporal frames or portions of the eye tracking data 602D for times T₁, T₂, . . . , T_{N}. In some implementations, each temporal frame of the eye tracking data 602D is conditioned by a pre-filter or otherwise pre-processed.

In various implementations, the input data processing architecture 600 includes a privacy subsystem 620 that includes one or more privacy filters associated with user information and/or identifying information (e.g., at least some portions of the audio data 602A, the physiological measurements 602B, the body pose data 602C, and/or the eye tracking data 602D). In some implementations, the privacy subsystem 620 includes an opt-in feature where the device informs the user as to what user information and/or identifying information is being monitored and how the user information and/or the identifying information will be used. In some implementations, the privacy subsystem 620 selectively prevents and/or limits the input data processing architecture 600 or portions thereof from obtaining and/or transmitting the user information. To this end, the privacy subsystem 620 receives user preferences and/or selections from the user in response to prompting the user for the same. In some implementations, the privacy subsystem 620 prevents the input data processing architecture 600 from obtaining and/or transmitting the user information unless and until the privacy subsystem 620 obtains informed consent from the user. In some implementations, the privacy subsystem 620 anonymizes (e.g., scrambles, obscures, encrypts, and/or the like) certain types of user information. For example, the privacy subsystem 620 receives user inputs designating which types of user information the privacy subsystem 620 anonymizes. As another example, the privacy subsystem 620 anonymizes certain types of user information likely to include sensitive and/or identifying information, independent of user designation (e.g., automatically).

In some implementations, the natural language processor (NLP) 622 is configured to perform natural language processing (or another speech recognition technique) on the audio data 602A or one or more temporal frames thereof. For example, the NLP 622 includes a processing model (e.g., a hidden Markov model, a dynamic time warping algorithm, or the like) or a machine learning node (e.g., a CNN, RNN, DNN, SVM, random forest algorithm, or the like) that performs speech-to-text (STT) processing. In some implementations, the trained qualitative feedback classifier 652 uses the text output from the NLP 622 to help determine the estimated user reaction state 672.

In some implementations, the speech assessor 624 is configured to determine one or more speech characteristics associated with the audio data 602A (or one or more temporal frames thereof). For example, the one or more speech characteristics corresponds to intonation, cadence, accent, diction, articulation, pronunciation, and/or the like. For example, the speech assessor 624 performs speech segmentation on the audio data 602A in order to break the audio data 602A into words, syllables, phonemes, and/or the like and, subsequently, determines one or more speech characteristics therefor. In some implementations, the trained qualitative feedback classifier 652 uses the one or more speech characteristics output by the speech assessor 624 to help determine the estimated user reaction state 672.

In some implementations, the biodata assessor 626 is configured to assess physiological and/or biological-related data from the user in order to determine one or more physiological measurements associated with the user. For example, the one or more physiological measurements corresponds to heartbeat information, respiratory rate information, blood pressure information, pupil dilation information, glucose level, blood oximetry levels, and/or the like. For example, the biodata assessor 626 performs segmentation on the physiological measurements 602B in order to break the physiological measurements 602B into a pupil dilation value, a heart rate value, a respiratory rate value, a blood glucose value, a blood oximetry value, and/or the like, and/or the like. In some implementations, the trained qualitative feedback classifier 652 uses the one or more physiological measurements output by the biodata assessor 626 to help determine the estimated user reaction state 672.

In some implementations, the body pose interpreter 628 is configured to determine one or more pose characteristics associated with the body pose data 602C (or one or more temporal frames thereof). For example, the body pose interpreter 628 determines an overall pose of the user (e.g., sitting, standing, crouching, etc.) for each sampling period (e.g., each image within the body pose data 602C) or predefined set of sampling periods (e.g., every N images within the body pose data 602C). For example, the body pose interpreter 628 determines rotational and/or translational coordinates for each joint, limb, and/or body portion of the user for each sampling period (e.g., each image within the body pose data 602C) or predefined set of sampling periods (e.g., every N images or M seconds within the body pose data 602C). For example, the body pose interpreter 628 determines rotational and/or translational coordinates for specific body parts (e.g., head, hands, and/or the like) for each sampling period (e.g., each image within the body pose data 602C) or predefined set of sampling periods (e.g., every N images or M seconds within the body pose data 602C). In some implementations, the trained qualitative feedback classifier 652 uses the one or more pose characteristics output by the body pose interpreter 628 to help determine the estimated user reaction state 672.

In some implementations, the gaze direction determiner 630 is configured to determine a directionality vector associated with the eye tracking data 602D (or one or more temporal frames thereof). For example, the gaze direction determiner 630 determines a directionality vector (e.g., X, Y, and/or focal point coordinates) for each sampling period (e.g., each image within the eye tracking data 602D) or predefined set of sampling periods (e.g., every N images or M seconds within the eye tracking data 602D). In some implementations, the user interest determiner 654 uses the directionality vector output by the gaze direction determiner 630 to help determine the user interest indication 674.

In some implementations, an input characterization engine 640 is configured to generate an input characterization vector 660 shown in FIG. 6 based on the outputs from the NLP 622, the speech assessor 624, the biodata assessor 626, the body pose interpreter 628, and the gaze direction determiner 630. As shown in FIG. 6, the input characterization vector 660 includes a speech content portion 662 that corresponds to the output from the NLP 622. For example, the speech content portion 662 may correspond to a user saying “Wow, I am stressed out,” which may indicate a state of stress.

In some implementations, the input characterization vector 660 includes a speech characteristics portion 664 that corresponds to the output from the speech assessor 624. For example, a speech characteristic associated with a fast speech cadence may indicate to a state of nervousness. As another example, a speech characteristic associated with a slow speech cadence may indicate a state of tiredness. As yet another example, a speech characteristic associated with a normal-paced speech cadence may indicate a state of concentration.

In some implementations, the input characterization vector 660 includes a physiological measurements portion 666 that corresponds to the output from the biodata assessor 626. For example, physiological measurements associated with a high respiratory rate and a high pupil dilation value may correspond to a state of excitement. As another example, physiological measurements associated with a high blood pressure value and a high heart rate value may correspond to a state of stress.

In some implementations, the input characterization vector 660 includes a body pose characteristics portion 668 that corresponds to the output from the body pose interpreter 628. For example, body pose characteristics that correspond to a user with crossed arms close to his/her chest may indicate a state of agitation. As another example, body pose characteristics that correspond to a user dancing may indicate a state of happiness. As yet another example, body pose characteristics that correspond to a user crossing/her his arms behind his/her head may indicate a state of relaxation.

In some implementations, the input characterization vector 660 includes a gaze direction portion 670 that corresponds to the output from the gaze direction determiner 630. For example, the gaze direction portion 670 corresponds to a vector indicating what the user is looking. In some implementations, the input characterization vector 660 also includes one or more miscellaneous information portions 672 associated with other input modalities.

In some implementations, the input data processing architecture 600 generates the input characterization vector 660 and stores the input characterization vector 660 in a data buffer 644 (e.g., a non-transitory memory), which is accessible to the trained qualitative feedback classifier 652 and the user interest determiner 654. In some implementations, each portion of the input characterization vector 660 is associated with a different input modality—the speech content potion 662, the speech characteristics portion 664, the physiological measurements portion 666, the body pose characteristics portion 668, the gaze direction portion 670, the miscellaneous information portion 672, or the like. One of ordinary skill in the art will appreciate that the input data processing architecture 600 may be structured or designed in myriad ways in other implementations to generate the input characterization vector 660.

In some implementations, the trained qualitative feedback classifier 652 is configured to output an estimated user reaction state 672 (or a confidence score related thereto) based on the input characterization vector 660 that includes information derived from the input data (e.g., the audio data 602A, the physiological measurements 602B, the body pose data 602C, and the eye tracking data 602D). Similarly, in some implementations, the user interest determiner 654 is configured to output a user interest indication 674 based on the input characterization vector 660 that includes information derived from the input data (e.g., the audio data 602A, the physiological measurements 602B, the body pose data 602C, and the eye tracking data 602D).

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

Moreover, FIG. 6 is intended more as a functional description of the various features which be present in a particular implementation as opposed to a structural schematic of the implementations described herein. As recognized by those of ordinary skill in the art, items shown separately could be combined and some items could be separated. For example, some functional modules shown separately in FIG. 6 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 7A is a block diagram of an example dynamic media item delivery architecture 700 in accordance with some implementations. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, the dynamic media item delivery architecture 700 is included in a computing system such as the controller 110 shown in FIGS. 1 and 2; the electronic device 120 shown in FIGS. 1 and 3; and/or a suitable combination thereof.

According to some implementations, the content manager 710 includes a media item selector 712 with an accompanying media item buffer 713 and a target metadata determiner 714. During runtime, the media item selector 712 obtains (e.g., receives, retrieves, or detects) an initial user selection 702. For example, the initial user selection 702 may correspond to a selection of a collection of media items (e.g., a photo album of images from a vacation or other event), one or more individually selected media items, a keyword or search string (e.g., Paris, rain, forest, etc.), and/or the like.

In some implementations, the media item selector 712 obtains (e.g., receives, retrieves, etc.) a first set of media items associated with first metadata from the media item repository 750 based on the initial user selection 702. As noted above, the media item repository 750 includes a plurality of media items such as A/V content and/or a plurality of virtual/XR objects, items, scenery, and/or the like. In some implementations, the media item repository 750 is stored locally and/or remotely relative to the dynamic media item delivery architecture 700. In some implementations, the media item repository 750 is pre-populated or manually authored by the user 150. The media item repository 750 is described in more detail below with reference to FIG. 7B.

In some implementations, when the first set of media items corresponds to virtual/XR content, the pose determiner 722 determines a current camera pose of the electronic device 120 and/or the user 150 relative to a location for the first set of media items and/or the physical environment. In some implementations, when the first set of media items corresponds to virtual/XR content, the renderer 724 renders the first set of media items according to the current camera pose relative thereto. According to some implementations, the pose determiner 722 updates the current camera pose in response to detecting translational and/or rotational movement of the electronic device 120 and/or the user 150.

In some implementations, when the first set of media items corresponds to virtual/XR content, the compositor 726 obtains (e.g., receives, retrieves, etc.) one or more images of the physical environment captured by the image capture device 370. Furthermore, in some implementations, the compositor 726 composites the first set of rendered media items with the one or more images of the physical environment to produce one or more rendered image frames. In some implementations, the compositor 726 obtains (e.g., receives, retrieves, determines/generates, or otherwise accesses) depth information (e.g., a point cloud, mesh, or the like) associated with the physical environment to maintain z-order and reduce occlusions between the first set of rendered media items and physical objects in the physical environment.

In some implementations, the A/V presenter 728 presents or causes presentation of the one or more rendered image frames (e.g., via the one or more displays 312 or the like). One of ordinary skill in the art will appreciate that the above steps may not be performed when the first set of media items corresponds to flat A/V content.

According to some implementations, the input data ingestor 615 ingests user input data, such as user reaction information and/or one or more affirmative user feedback inputs, gathered by the one or more input devices. In some implementations, the input data ingestor 615 also processes the user input data to generate a user characterization vector 660 derived therefrom. According to some implementations, the one or more input devices include at least one of an eye tracking engine, a body pose tracking engine, a heart rate monitor, a respiratory rate monitor, a blood glucose monitor, a blood oximetry monitor, a microphone, an image sensor, a body pose tracking engine, a head pose tracking engine, a limb/hand tracking engine, or the like. The input data ingestor 615 is described in more detail above with reference to FIG. 6.

In some implementations, the qualitative feedback classifier 652 generates an estimated user reaction state 672 (or a confidence score related thereto) to the first set of media items based on the user characterization vector 660. For example, the estimated user reaction state 672 may correspond to an emotional state or mood of the user 150 in reaction to the first set of media items such as happiness, sadness, excitement, stress, fear, and/or the like.

In some implementations, the user interest determiner 654 generates a user interest indication 674 based on one or more affirmative user feedback inputs within the user characterization vector 660. For example, the user interest indication 674 may correspond to a particular person, object, landmark, and/or the like that is the subject of the gaze direction of the user 150 is gazing at, a pointing gesture by the user 150, or a voice request from the user 150. As one example, while viewing the first set of media items, the computing system may detect that the gaze of the user 150 is fixated on a particular person within the first set of media items, such as his/her spouse or child, to indicate their interest therefor. As another example, while viewing the first set of media items, the computing system may detect a pointing gesture from the user 150 that is directed at a particular object within the first set of media items to indicate their interest therefor. As yet another example, while viewing the first set of media items, the computing system may detect a voice command from the user 150 that corresponds to selection or interest in a particular object, person, and/or the like within the first set of media items.

In some implementations, the target metadata determiner 714 determines one or more target metadata characteristics based on the estimated user reaction state 672, the user interest indication 674, and/or the first metadata associated with the first set of media items that is cached in the media item buffer 713. As one example, if the estimated user reaction state 672 corresponds to happiness and the user interest indication 674 corresponds to interest in a particular person, the one or more target metadata characteristics may correspond to happy times with the particular person.

As such, in various implementations, the media item selector 712 obtains a second set of items from the media item repository 750 that are associated with the one or more target metadata characteristics. As one example, the media item selector 712 selects the second set of media items the from the media item repository 750 that match the one or more target metadata characteristics. As another example, the media item selector 712 selects the second set of media items from the media item repository 750 that match the one or more target metadata characteristics within a predefined tolerance. Thereafter, when the second set of media items corresponds to virtual/XR content, the pose determiner 722, the renderer 724, the compositor 726, and the A/V presenter 728 repeat the operations mentioned above with respect to the first set of items.

In some implementations, the second set of media items is presented in a spatially meaningful way that accounts for the spatial context of the present physical environment and/or the past physical environment (or characteristics related thereto) associated with the second set of media items. As one example, if the first set of media items corresponds to an album of images of one's children engaging in a play date at one's home and the user fixates on a rug, couch, or other item of furniture within the first set of media items, the computing system may present the second set of media items (e.g., a continuation of the album of images of the user's children engaging in a play date at his/her home) relative to the rug, couch, or other item of furniture within the user's present physical environment as a spatial anchor. As another example, if the first set of media items corresponds to an album of images from a day at the beach and the user fixates on his/her child building a sand castle within the first set of media items, the computing system may present the second set of media items (e.g., a continuation of the album of images of the day at the beach) relative to a location within the user's present physical environment that matches at least some of the size, perspective, light direction, spatial features, and/or other characteristics associated with the past physical environment associated with the album of images of the day at the beach within some degree of tolerance or confidence.

Moreover, FIG. 7A is intended more as a functional description of the various features which be present in a particular implementation as opposed to a structural schematic of the implementations described herein. As recognized by those of ordinary skill in the art, items shown separately could be combined and some items could be separated. For example, some functional modules shown separately in FIG. 7A could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 7B illustrates an example data structure for the media item repository 750 in accordance with some implementations. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, the media item repository 750 includes a first entry 760A associated with a first media item 762A and an Nth entry 760N associated with an Nth media item 762N.

As shown in FIG. 7B, the first entry 760A includes intrinsic metadata 764A for the first media item 762A such as length/runtime when the first media item 762A corresponds to video and/or audio content, a size (e.g., in MBs, GBs, or the like), a resolution, a format, a creation date, a last modification date, and/or the like. In FIG. 7B, the first entry 760A also includes contextual metadata 766A for the first media item 762A such as a place or location associated with the first media item 762A, an event associated with the first media item 762A, one or more objects and/or landmarks associated with the first media item 762A, one or more people and/or faces associated with the first media item 762A, and/or the like.

Similarly, as shown in FIG. 7B, the Nth entry 760N includes intrinsic metadata 764N and contextual metadata 766N for the Nth media item 762N. One of ordinary skill in the art will appreciate that the structure of the media item repository 750 and the components thereof may be different in various other implementations.

FIG. 8A is a block diagram of another example dynamic media item delivery architecture 800 in accordance with some implementations. To that end, as a non-limiting example, the dynamic media item delivery architecture 800 is included in a computing system such as the controller 110 shown in FIGS. 1 and 2; the electronic device 120 shown in FIGS. 1 and 3; and/or a suitable combination thereof. The dynamic media item delivery architecture 800 in FIG. 8A is similar to and adapted from the dynamic media item delivery architecture 700 in FIG. 7A. As such, similar reference numbers are used herein and only the differences will be described for the sake of brevity.

As shown in FIG. 8A, the first set of media items and the estimated user reaction state 672 are stored in association within a user reaction history datastore 810. As such, in some implementations, the target metadata determiner 714 determines the one or more target metadata characteristics based on the estimated user reaction state 672, the user interest indication 674, the user reaction history datastore 810, and/or the first metadata associated with the first set of media items that is cached in the media item buffer 713.

Moreover, FIG. 8A is intended more as a functional description of the various features which be present in a particular implementation as opposed to a structural schematic of the implementations described herein. As recognized by those of ordinary skill in the art, items shown separately could be combined and some items could be separated. For example, some functional modules shown separately in FIG. 8A could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 8B illustrates an example data structure for the user reaction history datastore 810 in accordance with some implementations. With reference to FIG. 8B, the user reaction history datastore 810 includes a first entry 820A associated with a first media item 822A and an Nth entry 820N associated with an Nth media item 822N. As shown in FIG. 8B, the first entry 820A includes the first media item 822A, the estimated user reaction state 824A associated with the first media item 822A, the user input data 862A from which the estimated user reaction state 824A was determined, and also contextual information 828A such as the time, location, environmental measurements, and/or the like that characterize the context at the time the first media item 822A was presented.

Similarly, in FIG. 8B, the Nth entry 820N includes the Nth media item 822N, the estimated user reaction state 824N associated with the second media item 822N, the user input data 862N from which the estimated user reaction state 824N was determined, and also contextual information 828N such as the time, location, environmental measurements, and/or the like that characterize the context at the time the Nth media item 822N was presented. One of ordinary skill in the art will appreciate that the structure of the user reaction history datastore 810 and the components thereof may be different in various other implementations.

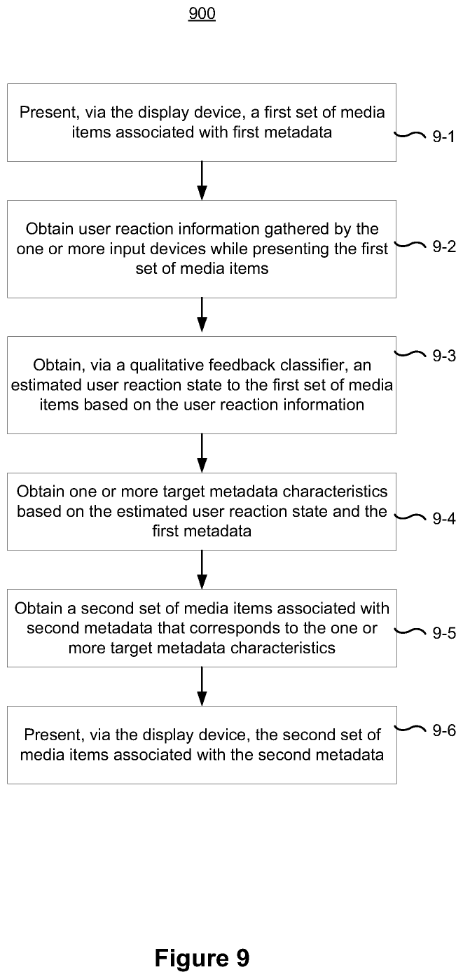

FIG. 9 is a flowchart representation of a method 900 of dynamic media item delivery in accordance with some implementations. In various implementations, the method 900 is performed at a computing system including non-transitory memory and one or more processors, wherein the computing system is communicatively coupled to a display device and one or more input devices (e.g., the electronic device 120 shown in FIGS. 1 and 3; the controller 110 in FIGS. 1 and 2; or a suitable combination thereof). In some implementations, the method 900 is performed by processing logic, including hardware, firmware, software, or a combination thereof. In some implementations, the method 900 is performed by a processor executing code stored in a non-transitory computer-readable medium (e.g., a memory). In some implementations, the electronic device corresponds to one of a tablet, a laptop, a mobile phone, a near-eye system, a wearable computing device, or the like.

In some instances, a user manually selects between groupings of images or media content that have been labeled based on geolocation, facial recognition, event, etc. For example, a user selects a Hawai′i vacation album and then manually selects a different album or photos that include a specific family member. In contrast, the method 900 describes a process by which a computing system dynamically updates an image or media content stream based on user reaction thereto such as gaze direction, body language, heart rate, respiratory rate, speech cadence, speech intonation, etc. As one example, while viewing a stream of media content (e.g., images associated with an event), the computing system dynamically changes the stream of media content based on the user's reaction thereto. For example, while viewing images associated with a birthday party, if the user's gaze focuses on a specific person, the computing systems transitions to displaying images associated with that person. As another example, while viewing images associated with a specific place or person, if the user exhibits an elevated heart rate and respiratory rate and eye dilation, the system may infer that the user is excited or happy and continues to display more images associated with the place or person.

As represented by block 9-1, the method 900 includes presenting a first set of media items associated with first metadata. For example, the first set of media items corresponds to an album of images, a set of videos, or the like. In some implementations, the first metadata is associated with a specific event, person, location/place, object, landmark, and/or the like.

For example, with reference to FIG. 7A, the computing system or a component thereof (e.g., the media item selector 712) obtains (e.g., receives, retrieves, etc.) a first set of media items associated with first metadata from the media item repository 750 based on the initial user selection 702. Continuing with this example, when the first set of media items corresponds to virtual/XR content, the computing system or a component thereof (e.g., the pose determiner 722) determines a current camera pose of the electronic device 120 and/or the user 150 relative to a location for the first set of media items and/or the physical environment.

Continuing with this example, when the first set of media items corresponds to virtual/XR content, the computing system or a component thereof (e.g., the renderer 724) renders the first set of media items according to the current camera pose relative thereto. According to some implementations, the pose determiner 722 updates the current camera pose in response to detecting translational and/or rotational movement of the electronic device 120 and/or the user 150. Continuing with this example, when the first set of media items corresponds to virtual/XR content, the computing system or a component thereof (e.g., the compositor 726) obtains (e.g., receives, retrieves, etc.) one or more images of the physical environment captured by the image capture device 370.

Furthermore, when the first set of media items corresponds to virtual/XR content, the computing system or a component thereof (e.g., the compositor 726) composites the first set of rendered media items with the one or more images of the physical environment to produce one or more rendered image frames. Finally, the computing system or a component thereof (e.g., the A/V presenter 728) presents or causes presentation of the one or more rendered image frames (e.g., via the one or more displays 312 or the like). One of ordinary skill in the art will appreciate that the above steps may not be performed when the first set of media items corresponds to flat A/V content.

As represented by block 9-2, the method 900 includes obtaining (e.g., receiving, retrieving, gathering/collecting, etc.) user reaction information gathered by the one or more input devices while presenting the first set of media items. In some implementations, the user reaction information corresponds to a user characterization vector derived therefrom that includes one or more intrinsic user feedback measurements associated with the user of the computing system including at least one of body pose characteristics, speech characteristics, a pupil dilation value, a heart rate value, a respiratory rate value, a blood glucose value, a blood oximetry value, or the like. For example, the body pose characteristics include head/hand/limb pose information such as joint positions and/or the like. For example, the speech characteristics include cadence, words-per-minute, intonation, etc.

For example, with reference to FIG. 7A, the computing system or a component thereof (e.g., the input data ingestor 615) ingests user input data such as user reaction information and/or one or more affirmative user feedback inputs gathered by one or more input devices. Continuing with this example, the computing system or a component thereof (e.g., the input data ingestor 615) also processes the user input data to generate a user characterization vector 660 derived therefrom. According to some implementations, the one or more input devices include at least one of an eye tracking engine, a body pose tracking engine, a heart rate monitor, a respiratory rate monitor, a blood glucose monitor, a blood oximetry monitor, a microphone, an image sensor, a body pose tracking engine, a head pose tracking engine, a limb/hand tracking engine, or the like. The input data ingestor 615 and the input characterization vector 660 are described in more detail above with reference to FIG. 6.

As represented by block 9-3, the method 900 includes obtaining (e.g., receiving, retrieving, or generating/determining), via a qualitative feedback classifier, an estimated user reaction state to the first set of media items based on the user reaction information. In some implementations, the qualitative feedback classifier corresponds to a trained ML system (e.g., a neural network, CNN, RNN, DNN, SVM, random forest algorithm, or the like) that ingests the user characterization vector (e.g., one or more intrinsic user feedback measurements) and outputs a user reaction state (e.g., an emotional state, mood, or the like) or a confidence score related thereto. In some implementations, the qualitative feedback classifier corresponds to a look-up engine that maps the user characterization vector (e.g., one or more intrinsic user feedback measurements) to a reaction table/matrix.

For example, with reference to FIG. 7A, the computing system or a component thereof (e.g., the trained qualitative feedback classifier 652) generates an estimated user reaction state 672 (or a confidence score related thereto) to the first set of media items based on the user characterization vector 660. For example, the estimated user reaction state 672 may correspond to an emotional state or mood of the user 150 in reaction to the first set of media items such as happiness, sadness, excitement, stress, fear, and/or the like.

As represented by block 9-4, the method 900 includes obtaining (e.g., receiving, retrieving, or generating/determining) one or more target metadata characteristics based on the estimated user reaction state and the first metadata. In some implementations, the one or more target metadata characteristics include at least one of a specific person, a specific place, a specific event, a specific object, or a specific landmark.

For example, with reference to FIG. 7A, the computing system or a component thereof (e.g., the target metadata determiner 714) determines one or more target metadata characteristics based on the estimated user reaction state 672, the user interest indication 674, and/or the first metadata associated with the first set of media items that is cached in the media item buffer 713. As one example, if the estimated user reaction state 672 corresponds to happiness and the user interest indication 674 corresponds to interest in a particular person, the one or more target metadata characteristics may correspond to happy times with the particular person.

In some implementations, the method 900 includes: obtaining sensor information associated with a user of the computing system, wherein the sensor information corresponds to one or more affirmative user feedback inputs; and generating a user interest indication based on the one or more affirmative user feedback inputs, wherein the one or more target metadata characteristics are determined based on the estimated user reaction state and the user interest indication. For example, the user interest indication corresponds to one of gaze direction, a voice command, a pointing gesture, or the like. In some implementations, the one or more affirmative user feedback inputs correspond to one of a gaze direction, a voice command, or a pointing gesture. As one example, if the estimated user reaction state 672 corresponds to happiness and the user interest indication 674 corresponds to interest in a particular person, the one or more target metadata characteristics may correspond to happy times with the particular person.

For example, with reference to FIG. 7A, the computing system or a component thereof (e.g., the user interest determiner 654) generates a user interest indication 674 based on one or more affirmative user feedback inputs within the user characterization vector 660. Continuing with this example, with reference to FIG. 7A, the computing system or a component thereof (e.g., the target metadata determiner 714) determines one or more target metadata characteristics based on the estimated user reaction state 672, the user interest indication 674, and/or the first metadata associated with the first set of media items that is cached in the media item buffer 713.

In some implementations, the method 900 includes linking the estimated user reaction state with the first set of media items in a user reaction history datastore. In some implementations, the user reaction history datastore can also be used in concert with the user interest indication and/or the user state indication to determine the one or more target metadata characteristics. The user reaction history datastore 810 is described above in more detail with respect to FIG. 8B. For example, with reference to FIG. 8A, the computing system or a component thereof (e.g., the target metadata determiner 714) determines the one or more target metadata characteristics based on the estimated user reaction state 672, the user interest indication 674, the user reaction history datastore 810, and/or the first metadata associated with the first set of media items that is cached in the media item buffer 713.

As represented by block 9-5, the method 900 includes obtaining (e.g., receiving, retrieving, or generating) a second set of media items associated with second metadata that corresponds to the one or more target metadata characteristics. For example, with reference to FIG. 7A, the computing system or a component thereof (e.g., the media item selector 712) obtains a second set of items from the media item repository 750 that are associated with the one or more target metadata characteristics. As one example, the media item selector 712 selects media items the from the media item repository 750 that match the one or more target metadata characteristics. As another example, the media item selector 712 selects media items the from the media item repository 750 that match the one or more target metadata characteristics within a predefined tolerance.

As represented by block 9-6, the method 900 includes presenting (or causing presentation of), via the display device, the second set of media items associated with the second metadata. For example, with reference to FIG. 7A, when the second set of media items corresponds to virtual/XR content, the computing system or component(s) thereof (e.g., the pose determiner 722, the renderer 724, the compositor 726, and the A/V presenter 728) repeat the operations mentioned above with reference to block 9-1 to present or cause presentation of the second set of media items.

In some implementations, the second set of media items is presented in a spatially meaningful way that accounts for the spatial context of the present physical environment and/or the past physical environment (or characteristics related thereto) associated with the second set of media items. As one example, if the first set of media items corresponds to an album of images of one's children engaging in a play date at one's home and the user fixates on a rug, couch, or other item of furniture within the first set of media items, the computing system may present the second set of media items (e.g., a continuation of the album of images of the user's children engaging in a play date at his/her home) relative to the rug, couch, or other item of furniture within the user's present physical environment as a spatial anchor. As another example, if the first set of media items corresponds to an album of images from a day at the beach and the user fixates on his/her child building a sand castle within the first set of media items, the computing system may present the second set of media items (e.g., a continuation of the album of images of the day at the beach) relative to a location within the user's present physical environment that matches at least some of the size, perspective, light direction, spatial features, and/or other characteristics associated with the past physical environment associated with the album of images of the day at the beach within some degree of tolerance or confidence.

In some implementations, the first and second sets of media items correspond to at least one of audio or visual content (e.g., images, videos, audio, and/or the like). In some implementations, the first and second sets of media items are mutually exclusive. In some implementations, the first and second sets of media items include at least one overlapping media item.

In some implementations, the display device corresponds to a transparent lens assembly, and wherein the first and second sets of media items are projected onto the transparent lens assembly. In some implementations, the display device corresponds to a near-eye system, and wherein presenting the first and second sets of media items includes compositing the first or second sets of media items with one or more images of a physical environment captured by an exterior-facing image sensor.

FIG. 10 is a block diagram of another example dynamic media item delivery architecture 1000 in accordance with some implementations. To that end, as a non-limiting example, the dynamic media item delivery architecture 1000 is included in a computing system such as the controller 110 shown in FIGS. 1 and 2; the electronic device 120 shown in FIGS. 1 and 3; and/or a suitable combination thereof. The dynamic media item delivery architecture 1000 in FIG. 10 is similar to and adapted from the dynamic media item delivery architecture 700 in FIG. 7A and the dynamic media item delivery architecture 800 in FIG. 8A. As such, similar reference numbers are used herein and only the differences will be described for the sake of brevity.

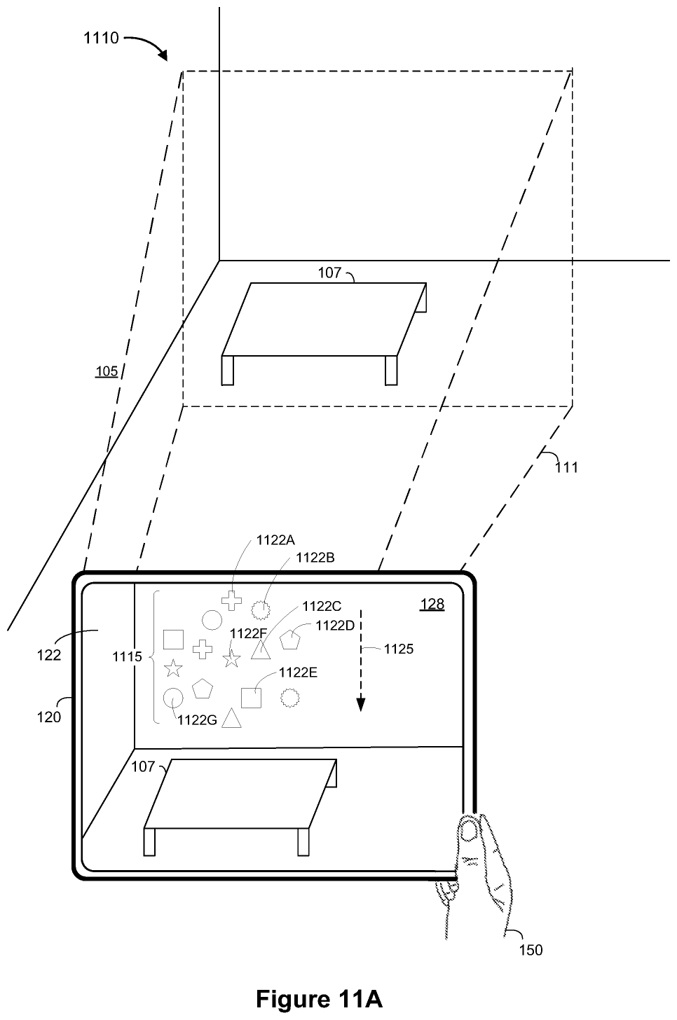

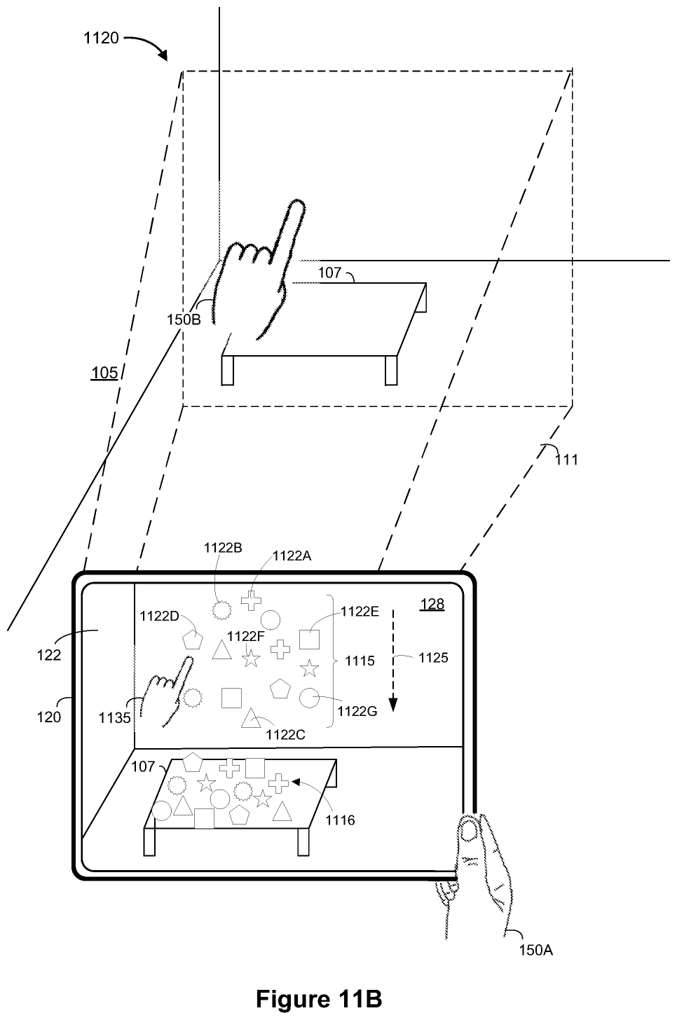

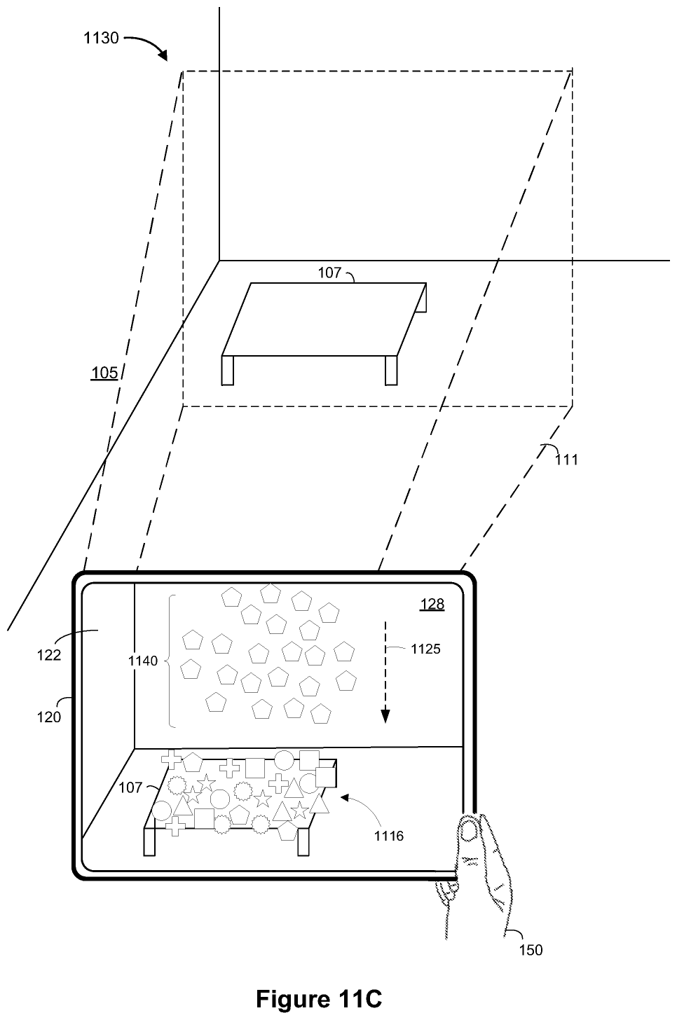

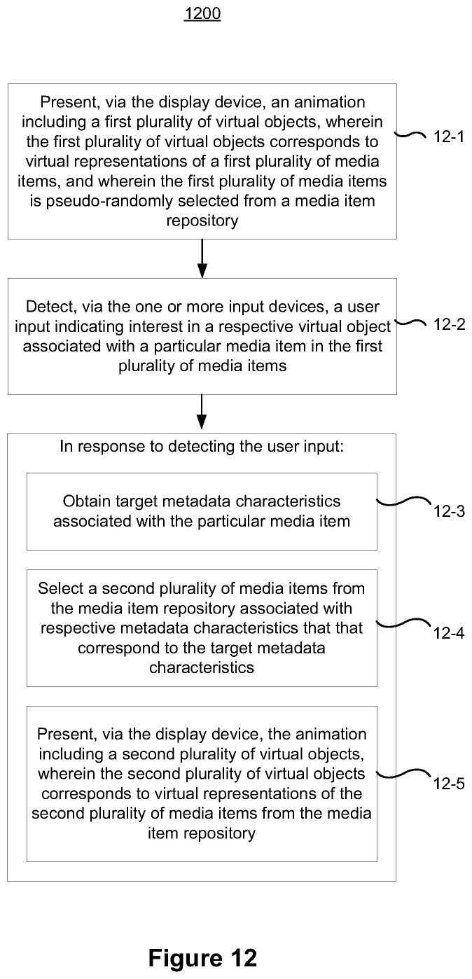

As shown in FIG. 10, the content manager 710 includes a randomizer 1010. For example, the randomizer 1010 may correspond to a randomization algorithm, a pseudo-randomization algorithm, a random number generator that utilizes a natural source of entropy (e.g., radioactive decay, thermal noise, radio noise, or the like), or the like. To this end, in some implementations, the media item selector 712 obtains (e.g., receives, retrieves, etc.) a first set of media items associated with first metadata from the media item repository 750 based a random or pseudo-random seed provided by the randomizer 1010. As such, the content manager 710 randomly selects the first set of media items in order to provide a serendipitous user experience that is described in more detail below with reference to FIGS. 11A-11C and 12.

Furthermore, in FIG. 10, in some implementations, the target metadata determiner 714 determines one or more target metadata characteristics based on the user interest indication 674 and/or the first metadata associated with the first set of media items that is cached in the media item buffer 713. As one example, if the user interest indication 674 corresponds to interest in a particular person, the one or more target metadata characteristics may correspond to the particular person. As such, in various implementations, the media item selector 712 obtains a second set of items from the media item repository 750 that are associated with the one or more target metadata characteristics.

Moreover, FIG. 10 is intended more as a functional description of the various features which be present in a particular implementation as opposed to a structural schematic of the implementations described herein. As recognized by those of ordinary skill in the art, items shown separately could be combined and some items could be separated. For example, some functional modules shown separately in FIG. 10 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIGS. 11A-11C illustrate a sequence of instances 1110, 1120, and 1130 for a serendipitous media item delivery scenario in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, the sequence of instances 1110, 1120, and 1130 are performed by a computing system such as the controller 110 shown in FIGS. 1 and 2; the electronic device 120 shown in FIGS. 1 and 3; and/or a suitable combination thereof.

As shown in FIGS. 11A-11C, the serendipitous media item delivery scenario includes a physical environment 105 and an XR environment 128 displayed on the display 122 of the electronic device 120. The electronic device 120 presents the XR environment 128 to the user 150 while the user 150 is physically present within the physical environment 105 that includes a table 107 within a field-of-view (FOV) 111 of an exterior-facing image sensor of the electronic device 120. As such, in some implementations, the user 150 holds the electronic device 120 in his/her hand(s) similar to the operating environment 100 in FIG. 1.

In other words, in some implementations, the electronic device 120 is configured to present virtual/XR content and to enable optical see-through or video pass-through of at least a portion of the physical environment 105 on the display 122. For example, the electronic device 120 corresponds to a mobile phone, tablet, laptop, near-eye system, wearable computing device, or the like.

As shown in FIG. 11A, during the instance 1110 (e.g., associated with time T₁) of the serendipitous media item delivery scenario, the electronic device 120 presents an XR environment 128 including a first plurality of virtual objects 1115 in a descending animation according to a gravity indicator 1125. Although the first plurality of virtual objects 1115 are illustrated in a descending animation centered about the representation of the table 107 within the XR environment 128 in FIGS. 11A-11C, one of ordinary skill in the art will appreciate that the descending animation may be centered about a different point within the physical environment 105 such as centered on the electronic device 120 or the user 150. Furthermore, although the first plurality of virtual objects 1115 are illustrated in a descending animation in FIGS. 11A-11C, one of ordinary skill in the art will appreciate that the descending animation may be replaced with other animations such as an ascending animation, a particle flow directed towards the electronic device 120 or the user 150, a particle flow directed away from the electronic device 120 or the user 150, or the like.

In FIG. 11A, the electronic device 120 displays the first plurality of virtual objects 1115 relative to or overlaid on the physical environment 105. As such, in one example, the first plurality of virtual objects 1115 are composited with optical see-through or video pass-through of at least a portion of the physical environment 105.

In some implementations, the first plurality of virtual objects 1115 includes virtual representations of media items with different metadata characteristics. For example, a virtual representation 1122A corresponds to one or more media items associated with first metadata characteristics (e.g., one or more images that include a specific person or at least his/her face). For example, a virtual representation 1122B corresponds to one or more media items associated with second metadata characteristics (e.g., one or more images that include a specific object such as dogs, cats, trees, flowers, etc.). For example, a virtual representation 1122C corresponds to one or more media items associated with third metadata characteristics (e.g., one or more images that are associated with a particular event such as a birthday party). For example, a virtual representation 1122D corresponds to one or more media items associated with fourth metadata characteristics (e.g., one or more images that are associated with a specific time period such as a specific day, week, etc.). For example, a virtual representation 1122E corresponds to one or more media items associated with fifth metadata characteristics (e.g., one or more images that are associated with a specific location such as a city, a state, etc.). For example, a virtual representation 1122F corresponds to one or more media items associated with sixth metadata characteristics (e.g., one or more images that are associated with a specific file type or format such as still images, live images, videos, etc.). example, a virtual representation 1122G corresponds to one or more media items associated with seventh metadata characteristics (e.g., one or more images that are associated with a particular system or user specified tag/flag such as a mood tag, an important flag, and/or the like).

In some implementations, the first plurality of virtual objects 1115 correspond to virtual representations of a first plurality of media items, wherein the first plurality of media items is pseudo-randomly selected from the media item repository 750 shown in FIGS. 7B and 10.

As shown in FIG. 11B, during the instance 1120 (e.g., associated with time T₂) of the serendipitous media item delivery scenario, the electronic device 120 continues presenting the XR environment 128 including the first plurality of virtual objects 1115 in the descending animation according to the gravity indicator 1125. As shown in FIG. 11B, the first plurality of virtual objects 1115 continues to “rain down” on the table 107 and a portion 1116 of the first plurality of virtual objects 1115 has accumulated on the representation of the table 107 within the XR environment 128.

As shown in FIG. 11B, the user holds the electronic device 120 with his/her right hand 150A and performs a pointing gesture within the physical environment 105 with his/her left hand 150B. As such, in FIG. 11B, the electronic device 120 or a component thereof (e.g., a hand/limb tracking engine) detects the pointing gesture with the user's left hand 150B within the physical environment 105. In response to detecting the pointing gesture with the user's left hand 150B within the physical environment 105, the electronic device 120 or a component thereof displays a representation 1135 of the user's left hand 150B within the XR environment 128 and also maps the tracked location of the pointing gesture with the user's left hand 150B within the physical environment 105 to a respective virtual object 1122D within the XR environment 128. In some implementations, the pointing gesture indicates user interest in the respective virtual object 1122D.

In response to detecting the point gesture indicating user interest in the respective virtual object 1122D, the computing system obtains target metadata characteristics associated with the respective virtual object 1122D. For example, the target metadata characteristics correspond to one or more of a specific event, person, location/place, object, landmark, and/or the like for a media item associated with the respective virtual object 1122D. As such, according to some implementations, the computing system selects a second plurality of media items from the media item repository associated with respective metadata characteristics that correspond to the target metadata characteristics. As one example, the respective metadata characteristics and the target metadata characteristics match. As another example, the respective metadata characteristics and the target metadata characteristics are similar within a predefined tolerance threshold.

As shown in FIG. 11C, during the instance 1130 (e.g., associated with time T₃) of the serendipitous media item delivery scenario, the electronic device 120 presents an XR environment 128 including the second plurality of virtual objects 1140 in a descending animation according to the gravity indicator 1125 in response to detecting the point gesture indicating user interest in the respective virtual object 1122D in FIG. 11B. In some implementations, the second plurality of virtual objects 1140 includes virtual representations of media items with respective metadata characteristics that correspond to the target metadata characteristics.

FIG. 12 is a flowchart representation of a method 1200 of serendipitous media item delivery in accordance with some implementations. In various implementations, the method 1200 is performed at a computing system including non-transitory memory and one or more processors, wherein the computing system is communicatively coupled to a display device and one or more input devices (e.g., the electronic device 120 shown in FIGS. 1 and 3; the controller 110 in FIGS. 1 and 2; or a suitable combination thereof). In some implementations, the method 1200 is performed by processing logic, including hardware, firmware, software, or a combination thereof. In some implementations, the method 1200 is performed by a processor executing code stored in a non-transitory computer-readable medium (e.g., a memory). In some implementations, the electronic device corresponds to one of a tablet, a laptop, a mobile phone, a near-eye system, a wearable computing device, or the like.

In some instances, current media viewing applications lack a serendipitous nature. Usually, a user simply selects an album or event associated with a pre-sorted group of images. In contrast, in method 1200 described below, virtual representations of images “rain down” within an XR environment, where the images are pseudo-randomly selected from a user's camera roll or the like. However, if the device detects user interest in one of the virtual representations, the “pseudo-random rain” effect is changed to virtual representations of images that correspond to the user interest. As such, in order to provide a serendipitous effect when viewing media, virtual representations of pseudo-randomly selected media items “rain down” within in an XR environment.

As represented by block 12-1, the method 1200 includes presenting (or causing presentation of) an animation including a first plurality of virtual objects via the display device, wherein the first plurality of virtual objects corresponds to virtual representations of a first plurality of media items, and wherein the first plurality of media items is pseudo-randomly selected from a media item repository. In some implementations, the media item repository includes at least one of audio or visual content (e.g., images, videos, audio, and/or the like). For example, with reference to FIG. 10, the computing system or a component thereof (e.g., the media item selector 712) obtains (e.g., receives, retrieves, etc.) a first plurality of media items from the media item repository 750 based a random or pseudo-random seed provided by the randomizer 1010. As such, the content manager 710 randomly selects the first set of media items in order to provide a serendipitous user experience that is described in more detail above with reference to FIGS. 11A-11C.

As shown in FIG. 11A, for example, the electronic device 120 presents an XR environment 128 including a first plurality of virtual objects 1115 in a descending animation according to the gravity indicator 1125. Continuing with this example, the first plurality of virtual objects 1115 includes virtual representations of media items with different metadata characteristics. For example, a virtual representation 1122A corresponds to one or more media items associated with first metadata characteristics (e.g., one or more images that include a specific person or at least his/her face). For example, a virtual representation 1122B corresponds to one or more media items associated with second metadata characteristics (e.g., one or more images that include a specific object such as dogs, cats, trees, flowers, etc.).

In some implementations, the first plurality of virtual objects corresponds to three-dimensional (3D) representations of the first plurality of media items. For example, the 3D representations correspond to 3D models, 3D reconstructions, and/or the like for the first plurality of media items. In some implementations, the first plurality of virtual objects corresponds to two-dimensional (2D) representations of the first plurality of media items.

In some implementations, the animation corresponds to a descending animation that emulates a precipitation effect centered on the computing system (e.g., rain, snow, etc.). In some implementations, the animation corresponds to a descending animation that emulates a precipitation effect offset a threshold distance from the computing system. In some implementations, the animation corresponds to a particle flow of first plurality of virtual objects directed towards the computing system. In some implementations, the animation corresponds to a particle flow of first plurality of virtual objects directed away from the computing system. One of ordinary skill in the art will appreciate that the above-mentioned animation types are non-limiting examples and that myriad animation types may be used in various other implementations.

As represented by block 12-2, the method 1200 includes detecting, via the one or more input devices, a user input indicating interest in a respective virtual object associated with a particular media item in the first plurality of media items. For example, the user input corresponds to one of a gaze direction, a voice command, a pointing gesture, or the like. In some implementations, the user input indicating interest in a respective virtual object may also be referred to herein as an affirmative user feedback input. For example, with reference to FIG. 10, the computing system or a component thereof (e.g., the input data ingestor 615) ingests user input data such as such as user reaction information and/or one or more affirmative user feedback inputs gathered by one or more input devices. According to some implementations, the one or more input devices include at least one of an eye tracking engine, a body pose tracking engine, a heart rate monitor, a respiratory rate monitor, a blood glucose monitor, a blood oximetry monitor, a microphone, an image sensor, a body pose tracking engine, a head pose tracking engine, a limb/hand tracking engine, or the like. The input data ingestor 615 is described in more detail above with reference to FIG. 6.

As shown in FIG. 11B, for example, the electronic device 120 or a component thereof (e.g., a hand/limb tracking engine) detects the pointing gesture with the user's left hand 150B within the physical environment 105. Continuing with this example, in response to detecting the pointing gesture with the user's left hand 150B within the physical environment 105, the electronic device 120 or a component thereof displays a representation 1135 of the user's left hand 150B within the XR environment 128 and also maps the tracked location of the pointing gesture with the user's left hand 150B within the physical environment 105 to a respective virtual object 1122D within the XR environment 128. In some implementations, the pointing gesture indicates user interest in the respective virtual object 1122D.

In response to detecting the user input, as represented by block 12-3, the method 1200 includes obtaining (e.g., receiving, retrieving, gathering/collecting, etc.) target metadata characteristics associated with the particular media item. In some implementations, the one or more target metadata characteristics include at least one of a specific person, a specific place, a specific event, a specific object, a specific landmark, and/or the like. For example, with reference to FIG. 10, the computing system or a component thereof (e.g., the target metadata determiner 714) determines one or more target metadata characteristics based on the user interest indication 674 (e.g., associated with the user input) and/or the metadata associated with the first plurality of media items that is cached in the media item buffer 713.

In response to detecting the user input, as represented by block 12-4, the method 1200 includes selecting a second plurality of media items from the media item repository associated with respective metadata characteristics that correspond to the target metadata characteristics. For example, with reference to FIG. 10, the computing system or a component thereof (e.g., the media item selector 712) obtains a second plurality of media items from the media item repository 750 that are associated with the one or more target metadata characteristics.

In response to detecting the user input, as represented by block 12-5, the method 1200 includes presenting (or causing presentation of) the animation including a second plurality of virtual objects via the display device, wherein the second plurality of virtual objects corresponds to virtual representations of the second plurality of media items from the media item repository. As shown in FIG. 11C, for example, the electronic device 120 presents an XR environment 128 including the second plurality of virtual objects 1140 in a descending animation according to the gravity indicator 1125 in response to detecting the point gesture indicating user interest in the respective virtual object 1122D in FIG. 11B. In some implementations, the second plurality of virtual objects 1140 includes virtual representations of media items with respective metadata characteristics that correspond to the target metadata characteristics.

As one example, the respective metadata characteristics and the target metadata characteristics match. As another example, the respective metadata characteristics and the target metadata characteristics are similar within a predefined tolerance threshold. In some implementations, the first and second pluralities of virtual objects are mutually exclusive. In some implementations, the first and second pluralities of virtual objects correspond to at least one overlapping media item.

In some implementations, the display device corresponds to a transparent lens assembly, and wherein presenting the animation includes projecting the animation including the first or second plurality of virtual objects onto the transparent lens assembly. In some implementations, the display device corresponds to a near-eye system, and wherein presenting the animation includes compositing the first or second plurality of virtual objects with one or more images of a physical environment captured by an exterior-facing image sensor.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first”, “second”, etc. may be used herein to describe various elements, these elements should not be limited by these terms. These terms are only used to distinguish one element from another. For example, a first media item could be termed a second media item, and, similarly, a second media item could be termed a first media item, which changing the meaning of the description, so long as the occurrences of the “first media item” are renamed consistently and the occurrences of the “second media item” are renamed consistently. The first media item and the second media item are both media items, but they are not the same media item.

The terminology used herein is for the purpose of describing particular implementations only and is not intended to be limiting of the claims. As used in the description of the implementations and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a computing system including non-transitory memory and one or more processors, wherein the computing system is communicatively coupled to a display device and one or more input devices:
presenting, via the display device, a first set of media items associated with first metadata;
obtaining user reaction information gathered by the one or more input devices while presenting the first set of media items;
obtaining, via a qualitative feedback classifier, an estimated user reaction state to the first set of media items based on the user reaction information;
obtaining one or more target metadata characteristics based on the estimated user reaction state and the first metadata;
obtaining a second set of media items associated with second metadata that corresponds to the one or more target metadata characteristics; and
presenting, via the display device, the second set of media items associated with the second metadata.

2. The method of claim 1, wherein the user reaction information corresponds to a user characterization vector that includes one or more intrinsic user feedback measurements associated with the user of the computing system including at least one of body pose characteristics, speech characteristics, a pupil dilation value, a heart rate value, a respiratory rate value, a blood glucose value, and a blood oximetry value.

3. The method of claim 1, wherein the qualitative feedback classifier corresponds to a look-up engine, a neural network, a convolutional neural network (CNN), a recurrent neural network (RNN), a deep neural network (DNN), a state vector machine (SVM), or a random forest algorithm.

4. The method of claim 1, wherein the one or more input devices include at least one of an eye tracking engine, a body pose tracking engine, a heart rate monitor, a respiratory rate monitor, a blood glucose monitor, a blood oximetry monitor, a microphone, an image sensor, a body pose tracking engine, a head pose tracking engine, or a limb/hand tracking engine.

5. The method of claim 1, further comprising:
obtaining sensor information associated with a user of the computing system, wherein the sensor information corresponds to one or more affirmative user feedback inputs; and
generating a user interest indication based on the one or more affirmative user feedback inputs, wherein the one or more target metadata characteristics are determined based on the estimated user reaction state and the user interest indication.

6. The method of claim 5, wherein the one or more affirmative user feedback inputs correspond to one of a gaze direction, a voice command, or a pointing gesture.

7. The method of claim 1, further comprising:
linking the estimated user reaction state with the first set of media items in a user reaction history datastore.

8. The method of claim 7, wherein determining the one or more target metadata characteristics includes determining the one or more target metadata characteristics based on the estimated user reaction state and the user reaction history datastore.

9. The method of claim 1, wherein the one or more target metadata characteristics include at least one of a specific person, a specific place, a specific event, a specific object, or a specific landmark.

10. A device comprising:
one or more processors;
a non-transitory memory;
an interface for communicating with a display device and one or more input devices; and
one or more programs stored in the non-transitory memory, which, when executed by the one or more processors, cause the device to:
present, via the display device, a first set of media items associated with first metadata;
obtain user reaction information gathered by the one or more input devices while presenting the first set of media items;
obtain, via a qualitative feedback classifier, an estimated user reaction state to the first set of media items based on the user reaction information;
obtain one or more target metadata characteristics based on the estimated user reaction state and the first metadata;
obtain a second set of media items associated with second metadata that corresponds to the one or more target metadata characteristics; and
present, via the display device, the second set of media items associated with the second metadata.

11. The device of claim 10, wherein the user reaction information corresponds to a user characterization vector that includes one or more intrinsic user feedback measurements associated with the user of the computing system including at least one of body pose characteristics, speech characteristics, a pupil dilation value, a heart rate value, a respiratory rate value, a blood glucose value, and a blood oximetry value.

12. The device of claim 10, wherein the one or more programs further cause the device to:
obtain sensor information associated with a user of the computing system, wherein the sensor information corresponds to one or more affirmative user feedback inputs; and
generate a user interest indication based on the one or more affirmative user feedback inputs, wherein the one or more target metadata characteristics are determined based on the estimated user reaction state and the user interest indication.

13. The device of claim 12, wherein the one or more affirmative user feedback inputs correspond to one of a gaze direction, a voice command, or a pointing gesture.

14. The device of claim 10, wherein the one or more programs further cause the device to:
linking the estimated user reaction state with the first set of media items in a user reaction history datastore.

15. The device of claim 14, wherein determining the one or more target metadata characteristics includes determining the one or more target metadata characteristics based on the estimated user reaction state and the user reaction history datastore.

16. The device of claim 10, wherein the one or more target metadata characteristics include at least one of a specific person, a specific place, a specific event, a specific object, or a specific landmark.

17. A non-transitory memory storing one or more programs, which, when executed by one or more processors of a device with an interface for communicating with a display device and one or more input devices, cause the device to:
present, via the display device, a first set of media items associated with first metadata;
obtain user reaction information gathered by the one or more input devices while presenting the first set of media items;
obtain, via a qualitative feedback classifier, an estimated user reaction state to the first set of media items based on the user reaction information;
obtain one or more target metadata characteristics based on the estimated user reaction state and the first metadata;
obtain a second set of media items associated with second metadata that corresponds to the one or more target metadata characteristics; and
present, via the display device, the second set of media items associated with the second metadata.

18. The non-transitory memory of claim 17, wherein the user reaction information corresponds to a user characterization vector that includes one or more intrinsic user feedback measurements associated with the user of the computing system including at least one of body pose characteristics, speech characteristics, a pupil dilation value, a heart rate value, a respiratory rate value, a blood glucose value, and a blood oximetry value.

19. The non-transitory memory of claim 17, wherein the one or more programs further cause the device to:
obtain sensor information associated with a user of the computing system, wherein the sensor information corresponds to one or more affirmative user feedback inputs; and
generate a user interest indication based on the one or more affirmative user feedback inputs, wherein the one or more target metadata characteristics are determined based on the estimated user reaction state and the user interest indication.

20. The non-transitory memory of claim 19, wherein the one or more affirmative user feedback inputs correspond to one of a gaze direction, a voice command, or a pointing gesture.

21. The non-transitory memory of claim 17, wherein the one or more programs further cause the device to:
linking the estimated user reaction state with the first set of media items in a user reaction history datastore.

22. The non-transitory memory of claim 21, wherein determining the one or more target metadata characteristics includes determining the one or more target metadata characteristics based on the estimated user reaction state and the user reaction history datastore.

23. The non-transitory memory of claim 17, wherein the one or more target metadata characteristics include at least one of a specific person, a specific place, a specific event, a specific object, or a specific landmark.
